(19) United States
(12) Patent Application Publication
(10) Pub. No.: US 2026/0001586 A1
(43) Pub. Date: Jan. 1, 2026

(54) WHEEL ORIENTATION MECHANISM, FOLDABLE FRAME AND CHILD STROLLER

(71) Applicant: WONDERLAND SWITZERLAND AG, Steinhausen (CH)

(72) Inventors: Leilei ZHENG, Dongguan, Guangdong (CN); Yubin CHEN, Dongguan, Guangdong (CN); Haitao WU, Dongguan, Guangdong (CN); Fangming LI, Dongguan, Guangdong (CN)

(21) Appl. No.: 18/880,630

(22) PCT Filed: Jul. 5, 2023
(86) PCT No.: PCT/EP2023/068607

§ 371 Date: Jan. 2, 2025

(30) Foreign Application Priority Data
Jul. 5, 2022 (CN) 202210794537.4
Apr. 7, 2023 (CN) 202310371672.2

(51) Int. Cl. B62B 7/06

(52) U.S. Cl. CPC B62B 7/062; B62B 2205/20

(57) ABSTRACT

A wheel orientation mechanism, a foldable frame, and a child stroller are provided. The wheel orientation mechanism includes: a driving part including a driving member and a triggering part, the triggering part is actuated by folding and unfolding actions of a frame, such that the driving member moves respectively in a first direction and a second direction opposite to each other; a locking part, the locking part carries out locking and unlocking respectively by movement of the driving member in the first direction and the second direction; and a dragging part including a first end and a second end, the first end is connected to the driving part, and the second end is connected to the locking part. The wheel orientation mechanism may automatically trigger action when the child stroller is in a folded state to rotate the wheel seat to a locked position, such that the child stroller in the folded state may be stably in an upright state, which is convenient for temporary storage.

This application is a National Stage application of PCT/EP2023/068607, entitled “WHEEL ORIENTATION MECHANISM, FOLDABLE FRAME AND CHILD STROLLER” and filed on July 5 2023, which claims the benefits of Chinese Application No. 202210794537.4, filed on Jul. 5, 2022, and Chinese Application No. 202310371672.2, filed on Apr. 7, 2023, both of which are incorporated herein by reference in their entirety.

### TECHNICAL FIELD

The application relates to a wheel orientation mechanism, a foldable frame, and a child stroller including the wheel orientation mechanism and the foldable frame.

### BACKGROUND

A child stroller may alleviate the fatigue caused by holding a baby for a long time and improve the comfort of people's lives. The child stroller includes a frame part and a wheel part. In order to facilitate storage and carrying when it is not used temporarily, the frame part of the child stroller is usually arranged to be foldable, thus reducing the occupied volume of the child stroller in storage.

However, the existing child strollers usually cannot be placed upright in folded state, or when they are placed upright in folded state, the folded child strollers are easy to be tipped over due to sliding of the wheels. Moreover, if a folded child stroller is laid flat, it still needs to occupy a relatively large storage space, resulting in inconvenient in use. Particularly, when a child stroller folded for a short time, the folded child stroller cannot be placed upright stably, this will bring a lot of inconvenience.

In addition, in order to facilitate moving and steering a child stroller, the wheels of the child stroller are generally universal wheels which may rotate freely. Furthermore, in order to facilitate the storage and transportation of the child strollers, may child strollers now have the function of folding.

### SUMMARY

In view of the above problem, a purpose of the application is to provide a wheel orientation mechanism which is convenient in use and simple in structure, and a child stroller including the wheel orientation mechanism as well.

For this, according to an aspect of the present disclosure, a wheel orientation mechanism is provided. The wheel orientation mechanism comprises: a driving part including a driving member and a triggering part, the triggering part is actuated by folding and unfolding actions of a frame, such that the driving member moves respectively in a first direction and a second direction opposite to each other; a locking part, the locking part carries out locking and unlocking respectively by movement of the driving member in the first direction and the second direction; and a dragging part including a first end and a second end, the first end is connected to the driving part, and the second end is connected to the locking part.

According to an embodiment, the triggering part rotates correspondingly through folding and unfolding actions of the frame, and the driving member moves against the triggering part.

According to an embodiment, the locking part further comprises a locking pin and a locking hole, when the frame is folded, the locking pin moves into the locking hole, and when the frame is unfolded, the locking pin moves away from the locking hole.

According to an embodiment, the first end of the dragging part is connected to an end of the driving member away from the triggering part, and the second end of the dragging part is connected to an end of the locking pin away from the locking hole.

According to an embodiment, the driving part further comprises a chute, and the driving member slides in the chute respectively along the first direction and the second direction.

According to an embodiment, the chute comprises a fixing part and an orientation part arranged therein, and the fixing part and the orientation part are respectively arranged at two opposite ends of the chute.

According to an embodiment, the driving member comprises an end part, an accommodation slot, and an orientation slot, the end part is located at an end of the driving member facing the triggering part, the accommodation slot is located at an end of the driving member away from the triggering part, and the orientation slot is located between the end part and the accommodation slot.

According to an embodiment, the end part further comprises a bevel angle at a side end thereof.

According to an embodiment, the orientation part in the chute passes through the orientation slot of the driving member.

According to an embodiment, the triggering part comprises a driving bevel surface and a concave curved surface, the driving bevel surface is located on one side of the triggering part, and the concave curved surface is arranged adjacent to the driving bevel surface and located on the other side of the triggering part.

According to an embodiment, when the frame is folded from an unfolded position, the end part of the driving member slides from abutting against the concave curved surface to abutting against the driving bevel surface; and when the frame is unfolded from a folded position, the end part of the driving member slides from abutting against the driving bevel surface to abutting against the concave curved surface.

According to an embodiment, when the frame is in a completely folded state, the end part of the driving member abuts against an end edge on a side of the driving bevel surface.

According to an embodiment, the wheel orientation mechanism further comprises a first reset member and a second reset member, the first reset member is arranged at the driving part, and the second reset member is arranged at the locking part.

According to an embodiment, the first reset member and the second reset member are both elastic members, and an elastic force of the first reset member is greater than that of the second reset member.

According to an embodiment, corresponding to the folded position of the frame, the first reset member is in a compressed state, and the second reset member is in a released state; and corresponding to the unfolded position of the frame, the first reset member is in a released state, and the second reset member is in a compressed state.

According to an embodiment, one end of the first reset member is fixed to the fixing part of the chute, and the other end of the first reset member is fixed to the driving member.

According to an embodiment, the second reset member is fixedly arranged above or below the locking pin of the locking part, or the second reset member is arranged in the accommodation slot and connected to the locking pin of the locking part.

According to an embodiment, the wheel orientation mechanism further comprises a guiding part including a guiding slot, and a part of the dragging part between the first end and the second end is located in the guiding slot.

According to an embodiment, the dragging part is a steel wire.

According to another aspect of the present disclosure, a child stroller is provided. The child stroller comprises the wheel orientation mechanism as described above, wherein the locking part is arranged at a pivot joint between the front leg and the wheel seat of the frame, and the driving part at least partially arranged at a pivot joint among the front leg, the rear leg, and the handlebar linkage part of the frame.

According to an embodiment, when the child stroller is folded, the triggering part rotates correspondingly with folding and unfolding actions of the frame, and the driving member moves against the triggering part.

According to an embodiment, the triggering part of the driving part is arranged at the pivot joint among the front leg, the rear leg, and the handlebar linkage part of the frame.

According to an embodiment, the locking hole of the locking part is arranged at the wheel seat of the wheel.

According to an embodiment, the guiding part is arranged at the front leg.

According to a further aspect of the present disclosure, a foldable frame and a child stroller are provided. The foldable frame and the child stroller may stand on the ground stably after being folded, so as to facilitate consumers to place the child stroller upright.

For this, a foldable frame is provided. The foldable frame comprises: a frame body, having an unfolded state and a folded state; a wheel assembly, rotatably connected to the frame body; a driving assembly, arranged on the frame body; and an orientation assembly, arranged between the frame body and the wheel assembly, the orientation assembly is unlocked when the frame body is in the unfolded state, such that the wheel assembly may be rotated with respect to the frame body, and the driving assembly may drive the orientation assembly to be locked when the frame body is in the folded state, such that the wheel assembly and the frame body are relatively fixed at a preset position.

According to an embodiment, the orientation assembly comprises an orientation element and an orientation slot, the orientation element is movably arranged on the frame body, the wheel assembly includes a wheel seat rotatably connected to the frame body, the orientation slot is arranged on the wheel seat and is offset from a rotation center of the wheel seat, and the orientation element may be inserted into the orientation slot when the wheel assembly is rotated to the preset position with respect to the frame body.

According to an embodiment, the orientation assembly further comprises a first reset member, two ends of the first reset member are respectively abutted against the frame body and the orientation element, and the first reset member always moves the orientation element in a direction close to the wheel seat.

According to an embodiment, the driving assembly comprises a driving member and a dragging part, two ends of the dragging part are respectively connected to the frame body and the driving member, the dragging part is tightened and always causes the driving member to drive the orientation element to move in a direction away from the wheel seat when the frame body is in the unfolded state, and the dragging part is loosened, and the orientation element moves in a direction close to the wheel seat under an action of the first reset member when the frame is in the folded state.

According to an embodiment, the driving member is rotatably arranged in the frame body, the driving member has a transmission tooth and has a first rotational position and a second rotational position, the driving member is rotated to the first rotational position when the dragging part is tightened, the transmission tooth push the orientation element along a direction away from the wheel seat, and the driving member is rotated to the second rotational position without pushing the orientation element along the direction away from the wheel seat when the dragging part is loosened.

According to an embodiment, an abutting and pushing element is arranged at a side of the orientation element, and the transmission tooth abuts against a side of the abutting and pushing element close to the wheel seat when the dragging part is tightened.

According to an embodiment, the driving assembly further comprises a second reset member, and the second reset member always rotates the driving member toward the second rotational position.

According to an embodiment, a driving tooth is arranged on the driving member, and the wheel seat is annularly provided with a plurality of tooth slots, the driving tooth may abut against a slot wall of any corresponding tooth slot to drive the wheel seat to rotate when the driving member is rotated.

According to an embodiment, when the driving tooth is inserted into any tooth slot, there is a gap between the driving tooth and the tooth slot.

According to an embodiment, a maximum width of the tooth slot is greater than a maximum width of a part of the driving tooth which is inserted into the tooth slot when the driving tooth is inserted into any tooth slot.

According to an embodiment, the driving tooth comprises a first bevel edge and a second bevel edge arranged at an included angle, the second bevel edge abuts against slot wall of any corresponding tooth slot, and an inclination angle of the first bevel edge is greater than that of the second bevel edge.

According to an embodiment, the frame body comprises a front leg support rod, an armrest support rod, and a foldable joint, the front leg support rod and the armrest support rod are pivotably connected to each other through the foldable joint, and the front leg support rod and the armrest support rod are fixedly unfolded with respect to each other when the foldable joint is in a locked state, the front leg support rod and the armrest support rod are folded with respect to each other when the foldable joint is in an unlocked state, and an end of the dragging part is connected to the foldable joint.

According to an embodiment, the frame body further comprises a fixing member, the fixing member is arranged at the foldable joint and is offset from a rotation center of the foldable joint, and an end of the dragging part is connected to the fixing member.

According to an embodiment, the driving assembly comprises a dragging part, two ends of the dragging part are respectively connected to the frame body and the orientation element, the dragging part is tightened and always moves the orientation element in a direction away from the wheel seat when the frame body is in the unfolded state, and the dragging part is loosened when the frame body is in the folded state, and the orientation element moves in a direction to close to the wheel seat under action of the first reset member.

According to an embodiment, the driving assembly further comprises a pulley fixed on the frame body, the dragging part partially surrounds on the pulley, and the pulley may make a portion of the dragging part close to the orientation element set in the same direction as the orientation element.

According to an embodiment, the foldable frame further comprises a rotation shaft, one end of the rotation shaft is fixed to one of the frame body and the wheel assembly, and the other of the frame body and the wheel assembly is provided with a pivot hole, and the other end of the rotation shaft is rotatably inserted into the pivot hole.

According to the present disclosure, a child stroller is also provided. The child stroller comprises the foldable frame as described above.

According to a further yet aspect of the present disclosure, a wheel orientation mechanism is provided. The wheel orientation mechanism includes: a driving guide part; a locking part, including a locking member and a locking hole; a dragging part, including a first end connected to a frame via the driving guide part and a second end connected to the locking member, and wherein the dragging part is tightened or loosened by the driving guide part along with an unfolding or folding action of the frame, such that the locking member is separated from or inserted into the locking hole to realize unlocking or locking.

According to an embodiment, the driving guide part includes a pulley group and a guide post group, and the pulley group and the guide post group are arranged along a moving path of the dragging part.

According to an embodiment, the pulley group includes a first pulley and a second pulley, the guide post group includes a first guide post and a second guide post, and the first end of the dragging part is connected to a handlebar assembly of the frame via the first pulley, the first guide post, the second guide post, and the second pulley in turn.

According to an embodiment, a rear leg of the frame is provided with a pivot joint, and a lower end of the pivot joint is pivoted to the rear leg of the frame, and an upper end of the pivot joint is pivoted to the handlebar assembly of the frame.

According to an embodiment, the first pulley and the second pulley are distributed on upper and lower sides of the pivot joint, and the first guide post and the second guide post are also distributed on upper and lower of the pivot joint.

According to an embodiment, distance between the first guide post and the second guide post in an extending direction of the front leg is smaller than distance between the first pulley and the second pulley in the extending direction of the front leg.

According to an embodiment, the first guide post and the second guide post, as well as the first pulley and the second pulley are all fixed pulleys or are all fixed posts.

According to an embodiment, the first guide post and the second guide post are fixed posts, and the first pulley and the second pulley are fixed pulleys.

According to an embodiment, the handlebar assembly includes a handlebar linkage part, the first end of the dragging part is connected to the handlebar linkage part, and the upper end of the pivot joint is pivoted to the handlebar linkage part.

According to an embodiment, the first pulley is arranged at a pivot connection between the pivot joint and the front leg, and the second pulley is arranged at a pivot connection between the pivot joint and the handlebar linkage part.

According to an embodiment, the locking part further includes a rotating part, and the locking member abuts against the rotating part after falling such that the locking hole is rotated to align with the locking member for locking.

According to an embodiment, the rotating part and the locking hole are both located on an end face of a wheel seat of the wheel faced to the frame.

According to an embodiment, the rotating part is a continuous spiral surface located on the end face, and the locking hole is located below the lowest point of the spiral surface.

According to an embodiment, a stepped surface is arranged between the lowest point of the spiral surface and the locking hole.

According to an embodiment, the locking part further includes an elastic member which abuts and pushes the locking member to lower it when folding the frame.

According to another aspect of the present disclosure, a wheel orientation mechanism is provided. The wheel orientation mechanism includes: a driving part; a locking part, including a locking member and a locking hole; a dragging part, including a first end connected to the driving part and a second end connected to the locking member, and wherein the dragging part moves between a first position in which the locking member is inserted into the locking hole to realize locking and a second position in which the locking member is separated from the locking hole to realize unlocking through the driving part along with an unfolding or folding action of the frame.

According to an embodiment, the driving part includes: a pushing member, rotating correspondingly along with an unfolding or folding action of the frame; and a sliding member, linearly moving to and fro through pushing of the pushing member.

According to an embodiment, the pushing member is provided at the front leg of the frame and includes: a pivot part around which the pushing member rotates; an abutting and pushing part, located at one end of the pushing member and protrudes outward, the abutting and pushing part abuts and pushes the sliding member when the frame is unfolded.

According to an embodiment, the sliding member is provided at the rear leg of the frame and includes: a sliding part which always abuts and supports a tube of the rear leg, and slides along the tube of the rear leg when the sliding member linearly moves; a protruding end, the abutting and pushing part abuts and pushes the protruding end when the frame is unfolded.

According to an embodiment, the pushing member further comprises a perforation part, the sliding member further comprises accommodating hole, the first end of the dragging part is fixed in the accommodating hole, the second end of the dragging part surrounds the pivot part, enters the front leg of the frame via the perforation part, and then fixes at the locking member.

According to an embodiment, a guiding slot is provided at the pivot part, and the second end of the dragging part surrounds the guiding slot, enters the front leg of the frame via the perforation part, and then fixes at the locking member.

According to an embodiment, the locking part further includes a rotating part, and the locking member abuts against the rotating part after falling such that the locking hole is rotated to align with the locking member for locking.

According to an embodiment, the rotating part and the locking hole are both located on an end face of a wheel seat of the wheel faced to the frame.

According to an embodiment, the rotating part is a spiral surface located on the end face, and the locking hole is located below the lowest point of the spiral surface.

According to an embodiment, the locking part further includes an elastic member which abuts and pushes the locking member to lower it when folding the frame.

The present disclosure further provides a child stroller comprising: a frame, including a handlebar assembly, a front leg, and a rear leg, and the handlebar assembly, the front leg, and the rear leg being pivotable with respect to each other at the pivot joint; wheels, each wheel including a wheel seat; and the wheel orientation mechanism described above.

The action of the wheel orientation mechanism may be automatically triggered to rotate wheel seat to a locked position when the child stroller is in the folded state, such that the child stroller in folded state may be stable in an upright state, which is convenient for temporary storage.

In addition, in the foldable frame according to the present disclosure, the orientation assembly is unlocked when the frame body is in the unfolded state, such that the wheel assembly may be rotated with respect to the frame body, thereby facilitating steering of the foldable frame. The driving assembly may drive the orientation assembly to be locked when the frame body is in folded state, such that the wheel assembly and the frame body may be relatively fixed at a preset position, for example, the position where the wheel assembly is located when the foldable frame advances linearly, the foldable frame in the folded state may stand stably on the ground, thus facilitating to be placed vertically by consumers and greatly saving the storage space.

On the other hand, the wheel orientation mechanism according to the present disclosure may make the wheels, especially the front wheels, rotate after the child stroller is folded, thereby avoiding interference with the frame, such as the frame crossbar, influencing folding of the frame, thus folding of the child stroller may be performed smoother.

### BRIEF DESCRIPTION OF THE DRAWINGS

The accompanying drawings are included for further understanding the invention and are incorporated in and constitute a part of this specification, which illustrate embodiments of the invention and together with the description below serve to explain the principles of the invention. In the drawings:

FIG. 1 is a schematic view showing a child stroller;

FIG. 2 is a schematic view showing the child stroller in an unfolded state;

FIG. 3 is a schematic view showing the child stroller in a folded state;

FIG. 4 is a schematic view showing a wheel orientation mechanism according to the application, in which the child stroller is in an unfolded state;

FIGS. 5 and 6 are enlarged views respectively showing the part A and the part B in FIG. 4;

FIG. 7 is a schematic view showing the wheel orientation mechanism according to the application, in which the child stroller is in a folded state;

FIGS. 8 and 9 are enlarged views respectively showing the part A and the part B in FIG. 7;

FIG. 10 is a structural schematic view of a foldable frame according to another embodiment of the invention, in which the foldable frame is in an unfolded state at this time;

FIG. 11 is a structural schematic view of the foldable frame according to another embodiment of the invention, in which the f foldable frame is in a folded state at this time;

FIG. 12 is a partial structural schematic view of the foldable frame shown in FIG. 10 from another view;

FIG. 13 is an enlarged view at “A” in FIG. 12;

FIG. 14 is a structural schematic view of a wheel assembly of the foldable frame shown in FIG. 10;

FIG. 15 is a partial side view of the foldable frame shown in FIG. 10;

FIG. 16 is an enlarged view at “B” in FIG. 15;

FIG. 17 is a partial side view of the foldable frame according to another embodiment of the invention, in which the foldable frame is in a half folded state at this time;

FIG. 18 is an enlarged view at “C” in FIG. 17;

FIG. 19 is a partial side view of the foldable frame shown in FIG. 11;

FIG. 20 is an enlarged view at “D” in FIG. 19;

FIG. 21 is a partial view of the foldable frame shown in FIG. 17;

FIG. 22 is an enlarged view at “E” in FIG. 21;

FIG. 23 is another side partial view of the foldable frame shown in FIG. 10;

FIG. 24 is an enlarged view at “F” in FIG. 23;

FIG. 25 is an enlarged view at “G” in FIG. 24;

FIG. 26 is an enlarged view at another “G” in FIG. 24;

FIG. 27 is a partial view of the foldable frame shown in FIG. 10;

FIG. 28 is an enlarged view at “H” in FIG. 27;

FIG. 29 is a partial view of the foldable frame shown in FIG. 11;

FIG. 30 is an enlarged view at “I” in FIG. 29;

FIG. 31 is another structural schematic view of the foldable frame shown in FIG. 10, in which a driving tooth abuts against a tooth slot at “M” at this time;

FIG. 32 is a further structural schematic view of the foldable frame shown in FIG. 10, in which a driving tooth abuts against a tooth slot at “N” at this time;

FIG. 33 is a partial view of the foldable frame shown in FIG. 15;

FIG. 34 is a partial view of the foldable frame shown in FIG. 17;

FIG. 35 is a partial view of the foldable frame shown in FIG. 19;

FIG. 36 is a structural schematic view of a driving member and a second reset member of the foldable frame shown in FIG. 10;

FIG. 37 is a partial view of a foldable frame according to a further embodiment of the invention, in which the foldable frame is in an unfolded state at this time;

FIG. 38 is a partial structural schematic view of FIG. 37;

FIG. 39 is another partial structural schematic view of FIG. 38;

FIG. 40 is a partial view of a foldable frame according to another one embodiment of the invention, in which the foldable frame is in an unfolded state;

FIG. 41 is an enlarged view at “J” in FIG. 40;

FIG. 42 is a partial side view of a foldable frame according to another one embodiment of the invention, in which the foldable frame is in an unfolded state;

FIG. 43 is an enlarged view at “K” in FIG. 42;

FIG. 44 is another partial side view of a foldable frame according to another one embodiment of the invention, in which the foldable frame is in a folded state;

FIG. 45 is an enlarged view at “L” in FIG. 44.

FIG. 46 is a schematic view showing a child stroller according to another embodiment of the application, in which the child stroller is in an unfolded state;

FIG. 47 is a schematic view showing a child stroller according to another embodiment of the application, in which the child stroller is in a folded state;

FIG. 48 is a schematic view showing the wheel orientation mechanism according to the application, in which a driving guide part and a locking part of the wheel orientation mechanism are shown, and the child stroller is shown in an unfolded state;

FIG. 49 is a schematic view showing the wheel orientation mechanism according to the application, in which a driving guide part and a locking part of the wheel orientation mechanism are shown, and the child stroller is shown in a folded state;

FIG. 50 is a schematic view showing the part “E” in FIG. 48 from another view;

FIG. 51 is a schematic view showing the rotating part and the locking hole according to the embodiment of the application;

FIG. 52 is a schematic view showing the locking part according to the embodiment of the application;

FIG. 53 is a schematic view showing different positional relationships of the locking part according to the embodiment of the application when the child stroller is in the unfolded state and the folded state;

FIG. 54 is a schematic view showing a child stroller according to a fourth embodiment of the application;

FIG. 55 is an enlarged schematic view showing the part “M” of the child stroller in FIG. 54;

FIG. 56 is another schematic view showing the child stroller according to the fourth embodiment of the application;

FIG. 57 is an enlarged schematic view showing the part “N” of the child stroller in FIG. 56;

FIG. 58 is an enlarged schematic view showing the structure of a sliding member according to the embodiment of the application;

FIG. 59 is an enlarged schematic view showing the structure of a locking part according to the embodiment of the application;

FIG. 60 is an enlarged schematic view showing the structure of the locking part according to the embodiment of the application, in which the locking part is in an unlocked state before rotating;

FIG. 61 is an enlarged schematic view showing the structure of the locking part according to the embodiment of the application, in which the locking part is in a locked state after rotating;

FIG. 62 is an enlarged schematic view showing a driving part and the locking part cooperated with each other according to the embodiment of the application, in which the child stroller is in an unfolded state; and

FIG. 63 is an enlarged schematic view showing the driving part and the locking part cooperated with each other according to the embodiment of the application driving, in which the child stroller is in a folded state.

### DETAILED DESCRIPTION

Hereinafter, exemplary embodiments will be described in detail with reference to the accompanying drawings. While the disclosure is susceptible to various modifications and alternative forms, specific embodiments thereof are shown by way of example in the accompanying drawings. However, this disclosure should not be construed as limited to the embodiments set forth herein, but on the contrary, the disclosure will cover all modifications, equivalents and alternatives falling within the spirit and scope of the embodiments.

In the following description, a child stroller is taken as an example. However, the wheel orientation mechanism according to the application is not limited to child strollers, but rather, is may other child devices which need to lock wheels.

First Embodiment

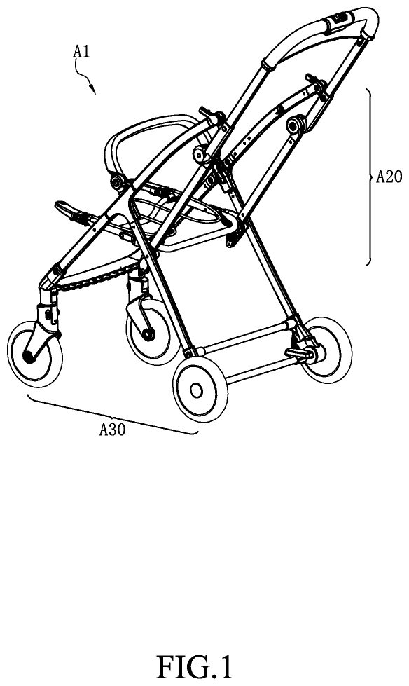

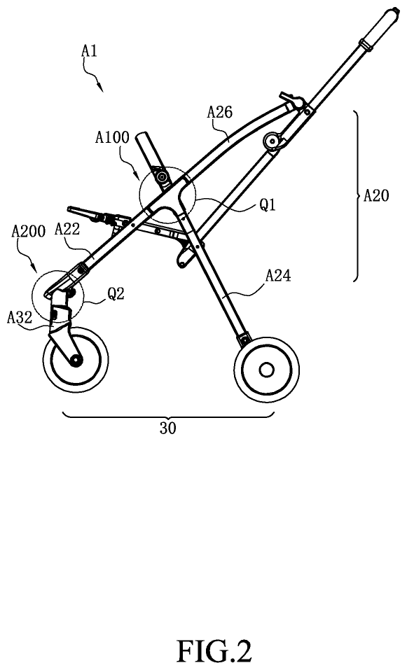

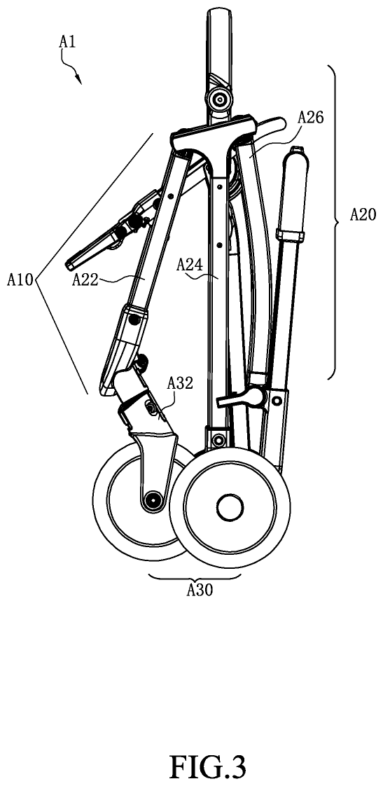

Hereinafter, a child stroller A1 according to a first embodiment of the application will be described with reference to FIGS. 1-3, in which FIG. 1 is a schematic view showing the child stroller; FIG. 2 is a schematic view showing the child stroller in an unfolded state; and FIG. 3 is a schematic view showing the child stroller in a folded state. As shown in FIG. 1, the child stroller A1 generally includes two parts: a frame A20, and wheels A30. In order to improve convenience of the child stroller A1 in use, especially for carrying or storing when it is not used temporarily, the part of the frame A20 of the child stroller A is usually foldable. Referring to FIGS. 2 and 3, in the unfolded state shown in FIG. 2, the child stroller A1 is in a working state and may carry a child to be pushed freely, while the child stroller A1 may be folded when it is not used temporarily, as shown in FIG. 3, which is convenient for carrying and temporary storage. In order to facilitate temporary storage of the child stroller A1 in folded state, generally, the child stroller A1 in folded state is expected to be able to stand straight stably, so as occupy a smaller storage space. However, if the wheels A30 of the child stroller A1 in folded state are not locked, they are prone easily slide, resulting in that the child stroller A1 in folded state cannot stand straight stably.

The child stroller A1 according to this embodiment is further provided with a wheel orientation mechanism A10. The action of the wheel orientation mechanism A10 may be automatically triggered to rotate wheel seats A32 to a locked position when the child stroller A1 is in the folded state, such that the child stroller A1 in folded state may be stable in an upright state, which is convenient for temporary storage.

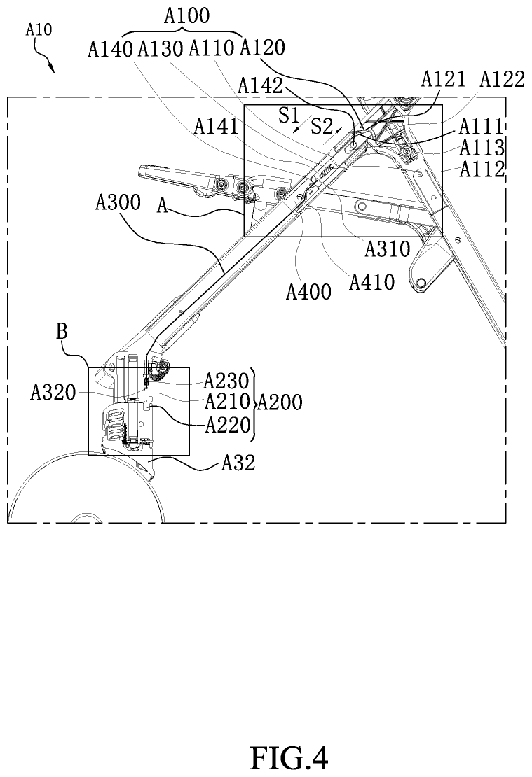

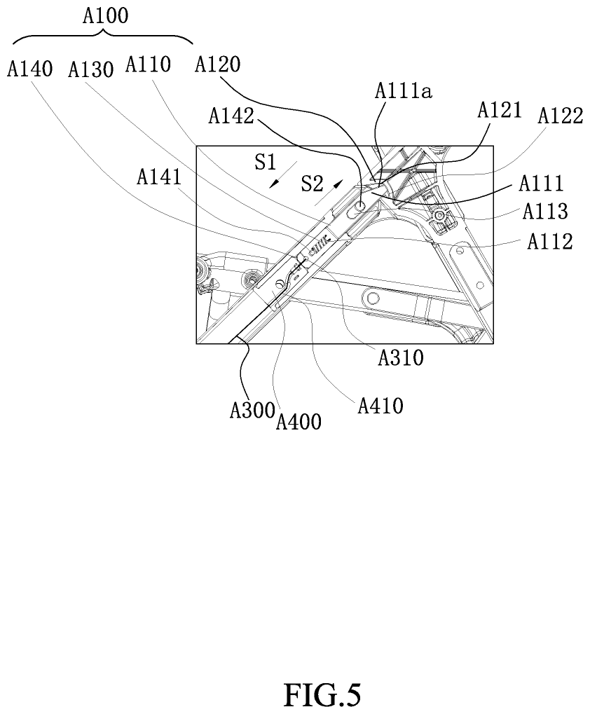

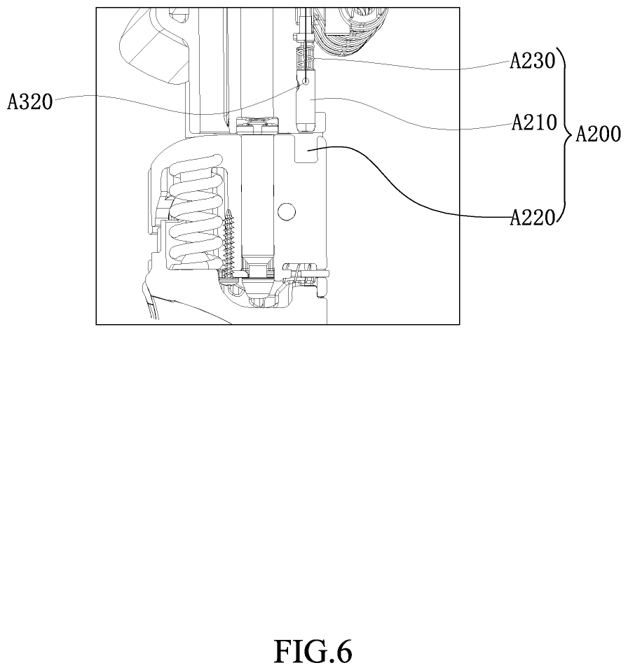

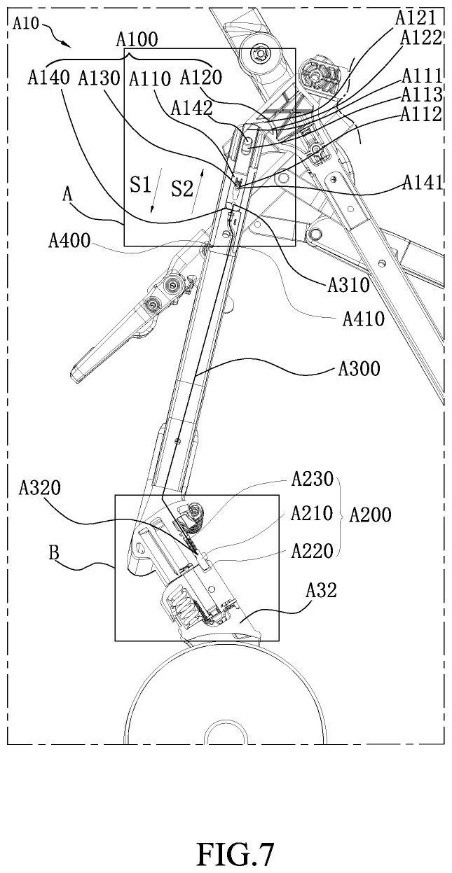

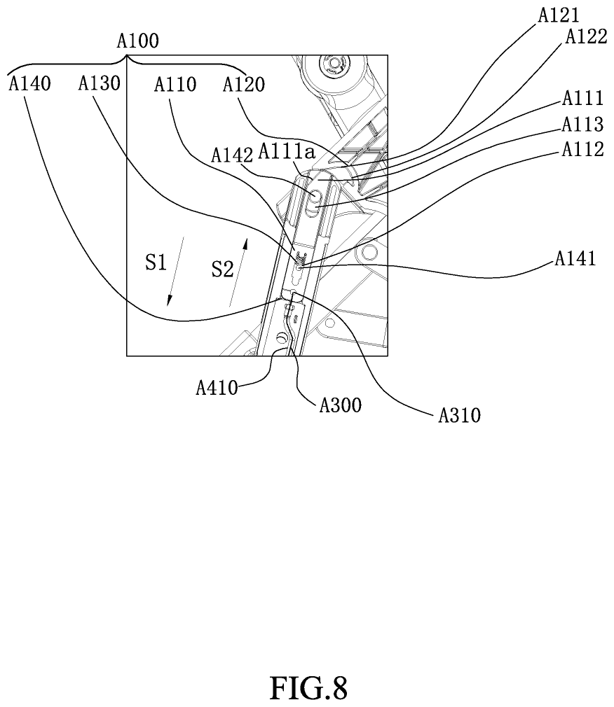

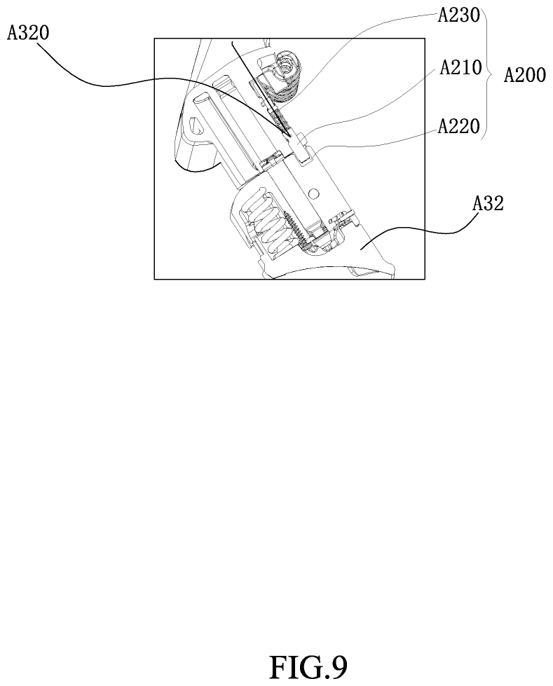

Hereinafter, the detailed structure of the wheel orientation mechanism according to this embodiment will be described in detail with reference to FIGS. 4 to 9, in which FIGS. 4-6 are corresponding to the child stroller in an unfolded state, FIG. 7-9 are corresponding to the child stroller in a folded state. Specifically, FIG. 4 is a schematic view showing the wheel orientation mechanism according to this embodiment, FIG. 5 is an enlarged view showing the part A in FIG. 4, FIG. 6 is an enlarged view showing the part B in FIG. 4; FIG. 7 is a schematic view showing the wheel orientation mechanism according to this embodiment, FIG. 8 is an enlarged view showing the part A in FIG. 7, and FIG. 9 is an enlarged view showing the part B in FIG. 7.

The main components of the wheel orientation mechanism A10 according to this embodiment include a driving part A100 and a locking part A200. A folding or unfolding of the child stroller A1 will automatically trigger the action of the driving part A100. For example, a folding action of the child stroller A1 may trigger the driving part A100 to move down, so as to drive the locking part A200 also to move down to a locked position. Moreover, when the child stroller A1 is unfolded, the driving part A100 will be triggered to move up, so as to drive the locking part A200 also to move up to an unlocked position.

Based on the embodiment shown in FIG. 2, the driving part A100 is, for example, at least partially arranged at a pivot joint among a front leg A22, a rear leg A24, and a handlebar linkage part A26 of the frame A20, i.e., at the position shown by the circle Q1 in FIG. 2, but of course it is not limited to this. The locking part A200 based on this embodiment is, for example, arranged at a pivot joint among the front leg A22 of the frame A20 and the wheel seat A32, i.e., at the position shown by the circle Q2 in FIG. 2, but it is not limited to this.

As shown in FIGS. 6 and 9, the locking part A200 mainly includes a locking pin A210 and a locking hole A220. The locking pin A210 may be moved down into the locking hole A220 to achieve a locking, or the locking pin A220 may be moved up away from the locking hole A220 to achieve an unlocking. According to the embodiment shown in FIGS. 4 and 7, the locking hole A220 is arranged at the wheel seat A32 of the wheel A30. The wheel A30 may be a front wheel, for example, and correspondingly, the wheel seat A32 may be a front wheel seat, but of course it is not limited to this.

Hereinafter, the main structure of the driving part A100 will be described in detail with reference to FIGS. 4 and 5. The driving part A100 mainly includes a driving member A110 and a triggering part A120. The triggering part A120 of the driving part A100 is concave in a whole, but it is not limited to this. The triggering part A120 is arranged at the pivot joint among the front leg A22, the rear leg A24, and the handlebar linkage part A26 of the frame A20, such that the triggering part rotates accordingly through the pivot of the handlebar linkage part A26 with respect to the front leg A22. According to a preferred embodiment, the triggering part A120 further includes a driving bevel surface A121 and a concave curved surface A122. As exemplarily shown in FIGS. 5 and 8, the driving bevel surface A121 is located on one side of the triggering part A120, for example, on the left side shown in FIGS. 5 and 8, and the concave curved surface A122 is arranged adjacent to the driving bevel surface A121 and on the other side of the triggering part A120 for example, on the right side shown in FIGS. 5 and 8.

The driving member A110 of the driving part A100 further includes an end part A111, an accommodation slot A112, and an orientation slot A113. The end part A111 is located at an end of the driving member A110 facing the triggering part A120, and the accommodation slot A113 is located at an end of the driving member A110 far away from the triggering part A120, and the orientation slot A113 is located between the end part A111 and the accommodation slot A112. The end part A111 of the driving member A110 abuts against the triggering part A120 cooperatively. Specifically, in unfolded state shown in FIG. 5, the end part A111 abuts against the concave curved surface A122 of the triggering part A120, while in the folded state shown in FIG. 8, the end part A111 abuts against the driving bevel surface A121 of the triggering part A120. Because the concave curved surface A122 may form a larger accommodating space than the driving bevel surface A121, the driving member A110 may be received in the triggering part A120 to a maximum extent when the end part A111 of the driving member A110 abuts against the concave curved surface A122, and at this time, the frame A20 of the child stroller A1 is corresponding to an unfolded position. Moreover, the end part A111 of the driving member A110 abuts against the driving bevel surface A121 when the frame A20 of the child stroller A1 is corresponding to a folded state, and the end part A111 of the driving member A110 abuts against an end edge on a side of the driving bevel surface A121 (e.g., the left side of the driving bevel surface A121 shown in FIG. 8) when the frame A20 of the child stroller A1 is completely folded, the driving member A110 almost exits the triggering part A120 at this time.

Based on the above structure, the triggering part A120 rotates correspondingly through folding and unfolding actions of the frame A20, and the driving member A110 moves against the triggering part A120. According to an embodiment, e.g. when the child stroller A1 is folded from an unfolded position, the handlebar linkage part A26 is pivoted downwardly with respect to the front leg A22, and the action of being pivoted downwardly causes the triggering part A120 to rotate clockwise as well, and the end part A111 originally abutting against the concave curved surface A122 will be driven by the triggering part A120 to move. Finally, the end part A11 will abut against the driving bevel surface A121. Because the concave curved surface A122 may form a larger accommodating space than the driving bevel surface A121, the driving part A100 moves down entirely when the end part Al111 of the driving part A100 abuts against the driving bevel surface A121, that is, the triggering part A120 is automatically triggered by the folding action of the child stroller A1 to perform action, and then the triggering part A120 urges the driving member A110 in a first direction S1. Finally, the end part A111 abuts against an end edge of one end of the driving bevel surface A121 when the child stroller A1 is bended and folded, so the driving member A110 almost exits the triggering part A120. Sliding of the driving member A110 in the first direction S1 may further trigger the action of the locking part A200, such that the locking pin A210 of the locking part A200 moves down into the locking hole A220 to achieve locking, such that the wheel seat A32 at this position is in the locked position.

Moreover, the handlebar linkage part A26 is pivoted upward with respect to the front leg A22 when the child stroller A1 is unfolded from the folded position, and the action of being pivoted upward causes the triggering part A120 to rotate counterclockwise accordingly, at this time, the end part A111 abutting against the driving bevel surface A121 will be driven by the triggering part A120 to move, and finally the end part A111 abuts against the concave curved surface A122. Since the concave curved surface A122 may provide a larger accommodating space than the driving bevel surface A121, the driving member A110 will move up entirely when the end part A111 abuts against the concave curved surface A122. That is, an action of the triggering part A120 may be automatically triggered by unfolding of the frame A20 of the child stroller, and then the triggering part A120 will urge the driving member A110 to slide upward along the second direction S2, such that the driving member A110 may be accommodated in the triggering part A120 to a maximum extent, and the upward sliding of the driving member A110 along the second direction S2 will further trigger an action of the locking part A200, such that the locking pin A210 of the locking part A200 moves up away from the locking hole A220 to achieve unlocking, so the wheel seats A32 at this position is in an unlocked position and the wheel may rotate freely. Pivoting of the triggering part A120 will be automatically triggered through the actions of folding and unfolding of the child stroller A1, and the driving part A100 will trigger the locked position and the unlocked position of the locking part A200.

Based on a preferred embodiment, a side of the end A111 is provided with a bevel angle A111a (as shown in FIG. 5), so as to avoid interference with the driving bevel surface A121 when the driving member A110 is accommodated in the triggering part A120.

In order to make the driving member A110 slide more smoothly in the first direction S1 and the second direction S2, according to a preferred embodiment, the driving part A100 further includes a chute A140. The driving member A110 slides in the first direction S1 or the second direction S2 along the chute A140 based on driving of the triggering part A120. The chute A140 is further provided with a fixing part A141 and an orientation part A142 therein. The fixing part A141 and the orientation part A142 are respectively arranged at the two opposite ends of the chute A140.

According to an embodiment, the orientation part A142 in the chute A140 passes through the orientation slot A113 of the driving member A110, so, during the process the driving member A110 sliding along the chute A140, there will be a relative sliding between the orientation part A142 and the orientation slot A113, and the orientation part A142 may orient and guide the sliding of the driving member A110. The fixing part A141 arranged in the chute A140 is configured to fix a first reset member A130 which will be described below.

A dragging part A300 is provided to realize an interconnection between the driving part A100 and the locking part A200. As shown in FIGS. 4 and 7, the dragging part A300 includes a first end A310 and a second end A320. The first end A310 is connected to the driving part A100, and the second end A320 is connected to the locking part A200. Based on an embodiment of the application, the dragging part A300 is a steel wire, but it is not limited to this. Specifically, the first end A310 of the dragging part A300 is connected to an end of the driving member A110 away from the triggering part A120, and the second end A320 of the dragging part A300 is connected to an end of the locking pin A210 away from the locking hole A220.

According to an embodiment, the wheel orientation mechanism A10 includes a guiding part A400. The guiding part A400 is arranged between the driving part A100 and the locking part A200, and the guiding part A400 is provided with a guiding slot A410 (as shown in FIGS. 5 and 8). A part of the dragging part A300 between its first end A310 and its second end A320 extends along the guiding slot A410 of the guiding part A400, so as to avoid the position of the dragging part A300 from deviation. According to an embodiment of the application, the guiding part A400 may be arranged at the front leg A22.

According to a preferred embodiment of the application, the wheel orientation mechanism A10 further includes a first reset member A130 and a second reset member A230. The first reset member A130 is arranged at the driving part A100, and the second reset member A230 is arranged at the locking part A200. For example, the first reset member A130 and the second reset member A230 are both elastic members (such as springs), but they are not limited to this. The elastic force of the first reset member A130 is greater than that of the second reset member A230.

In details, as shown in FIGS. 5 and 8, one end of the first reset member A130 is fixed to the fixing part A141 of the chute A140, and the other end of the first reset member A130 is fixed to the driving member A110. As shown in FIGS. 6 and 9, the second reset member A230 is fixedly arranged above the locking pin A210, but of course it is not limited to this, rather, the second reset member A230 may also be fixedly arranged below the locking pin A210. Furthermore, an accommodation slot may also be provided to accommodate the second reset member A230, so as to guide the movement of the second reset member A230 during compression and release.

When the child stroller A1 begins to be folded from the unfolded stat, the downward pivoting of the handlebar linkage part A26 with respect to the front leg A22 automatically triggers the triggering part A120 to rotate clockwise, and the end part A111 of the driving member A110 will be driven by the triggering part A120 to move. Finally, in a bended and folded state of the child stroller A1, the end part A111 abuts against an end edge on the left side of the driving bevel surface A121, such that the driving member A110 is driven to slide down in the first direction S1 (as shown in FIG. 8), and at this time, the first reset member A130 arranged at the driving part A100 is compressed. Moreover, since the driving member A110 moves down in the first direction S1, the dragging part A300 is released from original tension state, such that the second reset member A230, which was originally in a compressed state, is also released from its compressed state, thereby forcing the locking pin A210 to move down into the locking hole A220, and the wheel seat A32 rotated to this position is locked at this time. Therefore, corresponding to the child stroller A1 in the folded position, the first reset member A130 is in a compressed state, and the second reset member A230 is in a released state.

When the child stroller A1 begins to be unfolded from the folded state, the upward pivoting of the handlebar linkage part A26 with respect to the front leg A22 will automatically trigger the triggering part A120 to rotate counterclockwise, and the end part A111 of the driving member A110 will be driven by the triggering part A120 to move, and finally, the end part A111 will abut against the concave curved surface A122 of the triggering part A120. At this time, the driving member A110 will be accommodated in the accommodation space formed by the concave curved surface A122 of the triggering part A120 to maximum extent, so the driving member A110 moves up along the second direction S2, and the first reset member A130, which was originally in a compressed state, will be released from its compressed state at this time, so as to further drive the driving member A110 to move up, and thus pull the locking pin A210 up through the dragging part A300, and finally pull the locking pin A210 up away from the locking hole A220, thereby realizing the unlocking of the wheel seats A32, and the wheel may rotate freely. Since the elastic force of the first reset member A130 is greater than that of the second reset member A230, it may be ensured that the second reset member A230 is kept in its compressed state by the elastic force of the first reset member A130, thereby keeping the locking pin A210 at the position away from the locking hole A220. It may be known from the above, corresponding to the child stroller Al in the unfolded position, the first reset member A130 is in a released state, and the second reset member A230 is in a compressed state.

The wheel orientation mechanism according to this embodiment is arranged to rotationally lock the wheel seat of the wheel when the child stroller is in a folded state, such that the child stroller in folded state may be stored upright stably, further reducing the storage space required by the folded child stroller, and improving the convenience of the child stroller in use. Moreover, in the unfolded state of the child stroller, the wheel orientation mechanism according to this embodiment may unlock the locked state of the wheel seat, such that the wheel seat may rotate freely. The wheel orientation mechanism according to this embodiment is simple in structure and convenient to actuate, and the action of the wheel orientation mechanism may be automatically triggered with a folding of the frame, such that the automatic rotation of the wheel seat may be locked without additional wheel locking operation. Likely, unfolding of the frame may also automatically trigger the action of the wheel orientation mechanism, such that the lock of the wheel seat may be automatically unlocked and the wheel may rotate freely.

### Second Embodiment

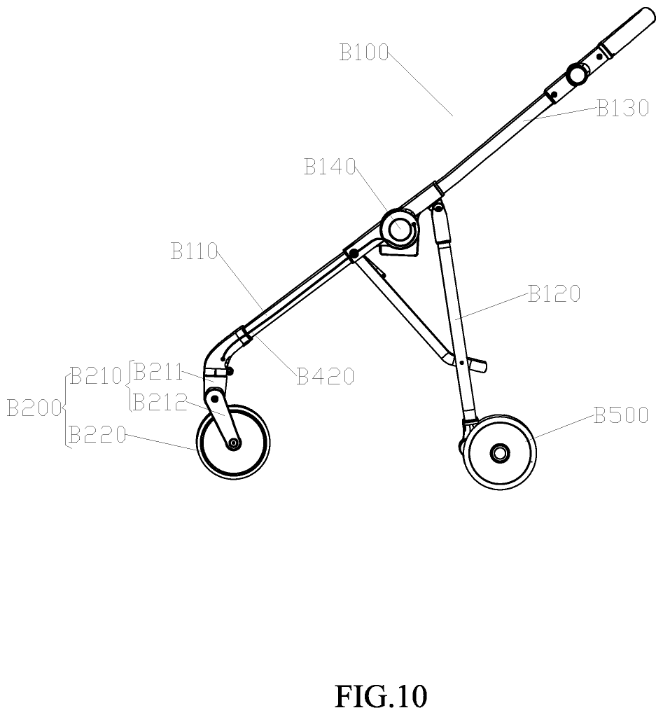

For a child stroller available in the current market, after being folded, it is often difficult for the child stroller to stand on the ground stably on the ground because its wheels are prone to rotate to inappropriate positions, which brings inconvenience to consumers. As shown in FIG. 10, the second embodiment of the invention provides a child stroller with a foldable frame. The child stroller and the foldable frame may stand on the ground stably after being folded, which is convenient for consumers to place the child stroller straightly.

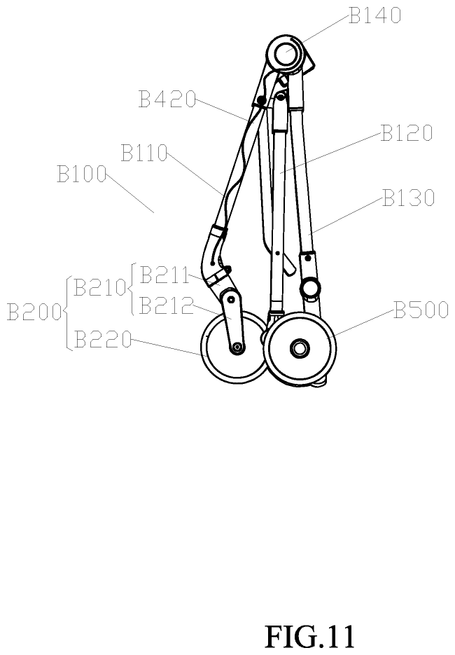

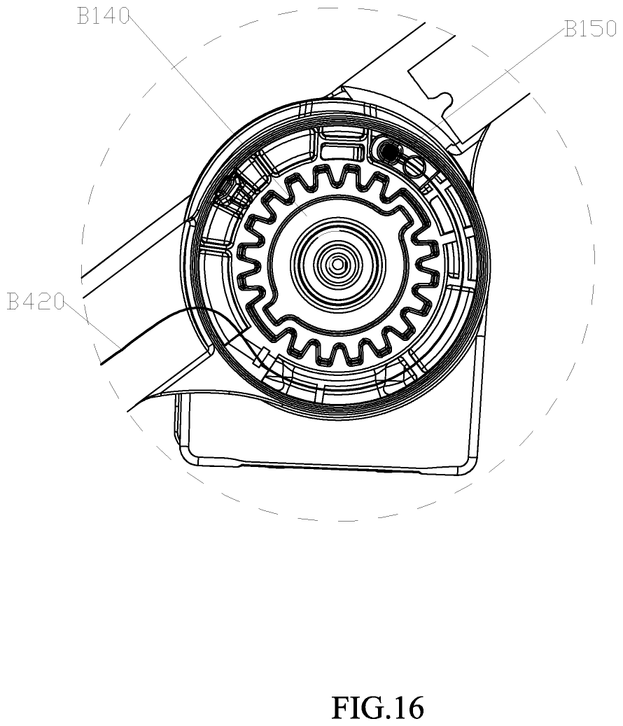

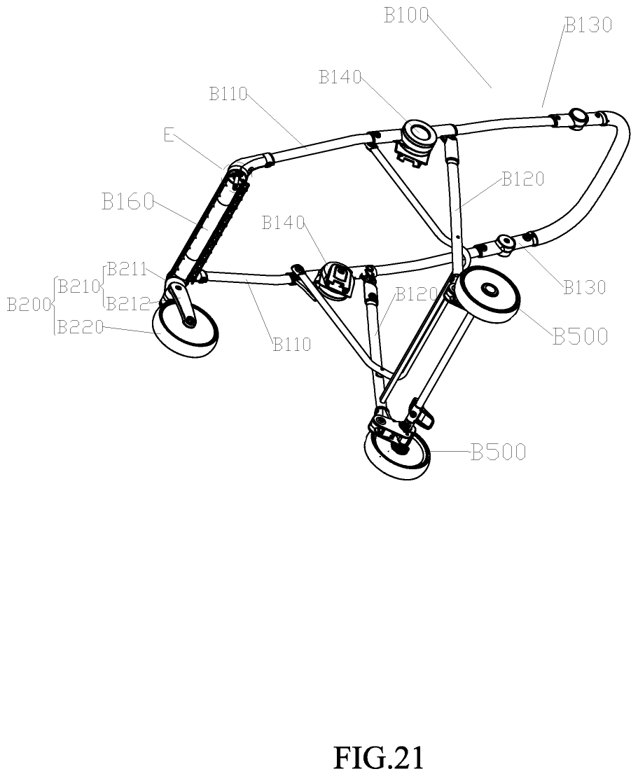

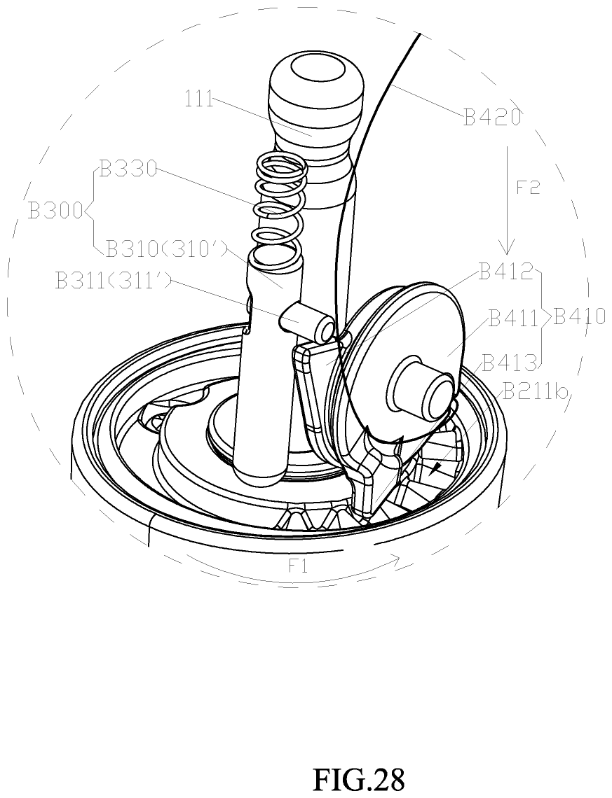

In details, as shown in FIGS. 10 and 28, the foldable frame includes a frame body B100, a wheel assembly B200, an orientation assembly B300, a driving assembly B400, and a transmission wheel B500. As shown in FIGS. 10, 16, and 21, the frame body B100 includes two front leg support rods B110, two rear leg support rods B120, two armrest support rods B130, two foldable joints B140, two fixing members B150, and a pedal B160, in which the two front leg support rods B110, the two rear leg support rods B120, the two armrest support rods B130, the two foldable joints B140, and the two fixing members B150 are respectively located at two opposite sides of the frame body B100. In this embodiment, the pedal B160 is fixed to bottom ends of the two front leg support rods B110. Of course, in other embodiments, the pedal B160 may also be connected between the two front leg support rods B110, or the pedal B160 may be omitted. Taking the front leg support rod B110, the rear leg support rod B120, the armrest support rod B130, the foldable joint B140, and the fixing member B150 on one side as an example, the front leg support rod B110 and the armrest support rod B130 are pivotably connected to each other through the foldable joint B140, and the rear leg support rod B120 is pivotably connected on the armrest support rod B130. The frame body B100 has an unfolded state and a folded state. As shown in FIG. 10, when the foldable joints B140 is in a locked state, the front leg support rod B110 and the armrest support rod B130 are fixedly unfolded with respect to each other, that is, the frame body B100 is in the unfolded state for use. As shown in FIG. 11, when the foldable joints B140 is in an unlocked state, the front leg support rod B110 and the armrest support rod B130 may be folded respect to each other until the front leg support rod B110, the rear leg support rod B120, and the armrest support rod B130 are roughly coincident or parallel, that is, the frame body B100 is in the folded state for storage. As shown in FIG. 16, the foldable joints B140 has a generally disc-shaped structure, and the fixing member B150 is arranged at the foldable joints B140 and is offset from a rotation center of the foldable joints B140.

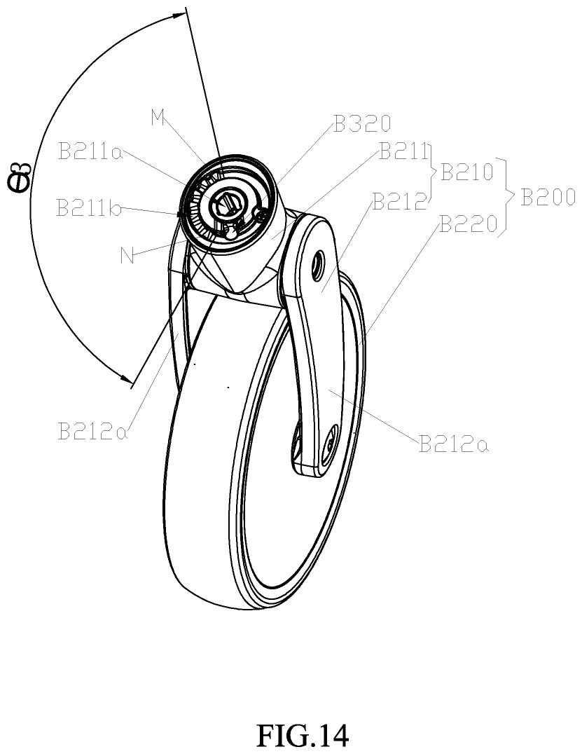

In details, as shown in FIG. 10, the wheel assembly B200 includes a wheel seat B210 and a wheel body B220. The wheel seat B210 includes a connecting seat 211 and a connecting frame B212 connected to each other. As shown in FIG. 14, the connecting seat 211 is roughly cylindrical, and an end of the connecting seat 211 away from the connecting frame B212 is provided with a pivot hole B211a. The connecting frame B212 includes two connecting members B212a which are oppositely arranged, and both ends of a rotation shaft of the wheel body B220 are pivotably connected to the two connecting members B212 respectively. In this embodiment, the wheel seat B210 has an integrated structure. Of course, in other embodiments, the wheel seat B210 may also be formed by connecting the connecting seat 211 and the connecting frame B212 which are independent to each other.

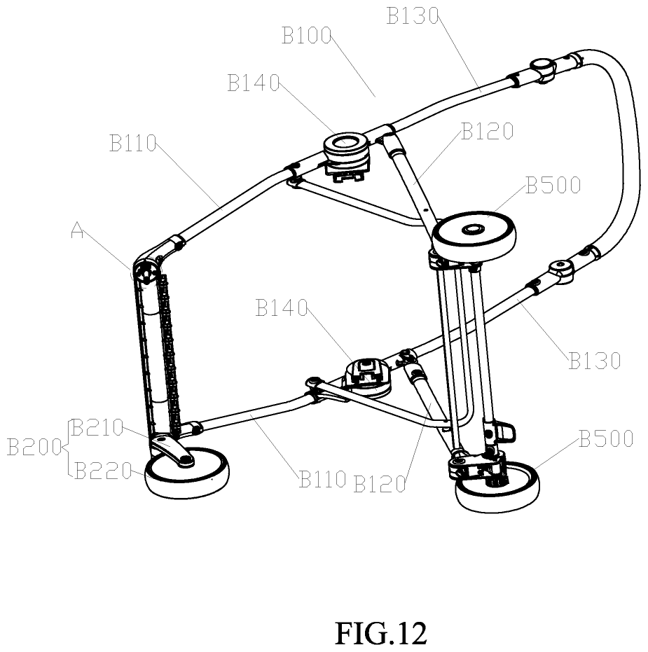

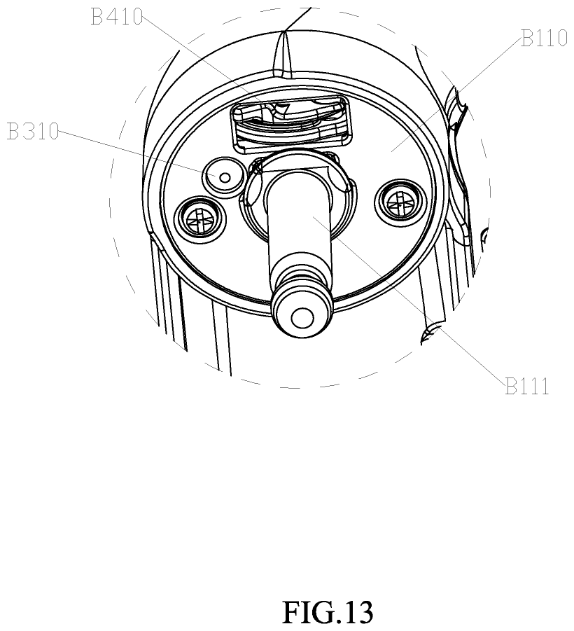

In this embodiment, as shown in FIGS. 12 to 14, two rotation shafts B111 at intervals are provided at a bottom end of the pedal B160, and there are two wheel assemblies B200. The two rotation shafts B111 are rotatably inserted into the pivot holes B211a of the two connecting seat 211 of the two wheel assemblies B200 respectively. Of course, in the embodiment where the pedal B 160 is connected between the two front leg support rods B110, or the pedal B160 is omitted, the two rotation shafts B111 may also be arranged at bottom ends of the two front leg support rods B110. Moreover, unsteerable transmission wheels B500 are fixed at bottom ends of the two rear leg support rods B120. Of course, in other embodiments, the rotation shafts B111 may also be fixed on the connecting seats 211 of the wheel assemblies B200, and rotatably connected to the bottom end of the pedal B160. In addition, in other embodiments, the wheel assembly B200 may also be provided at the bottom ends of rear leg support rods B120.

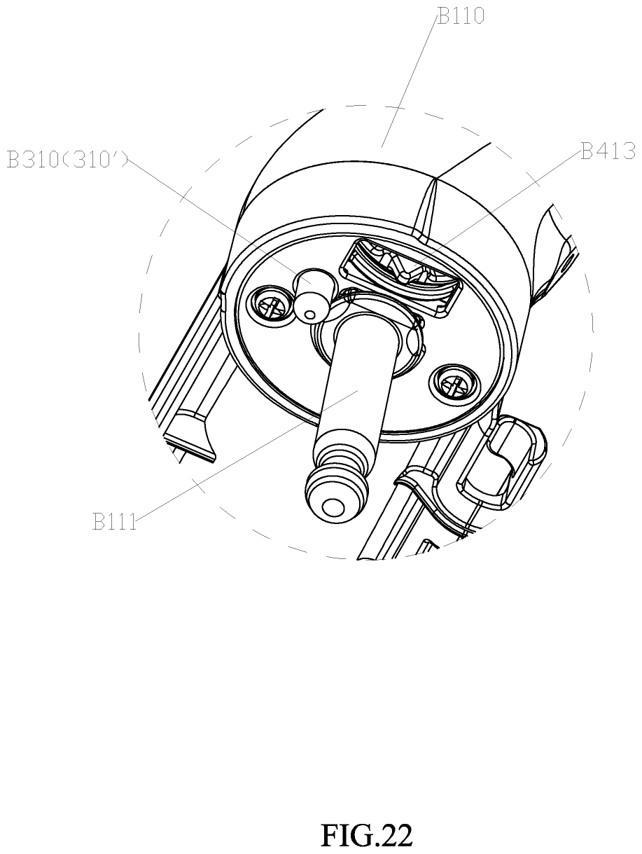

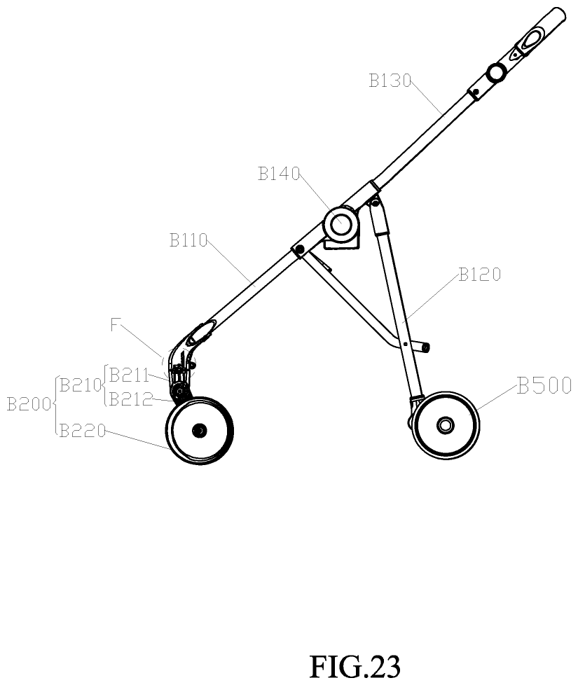

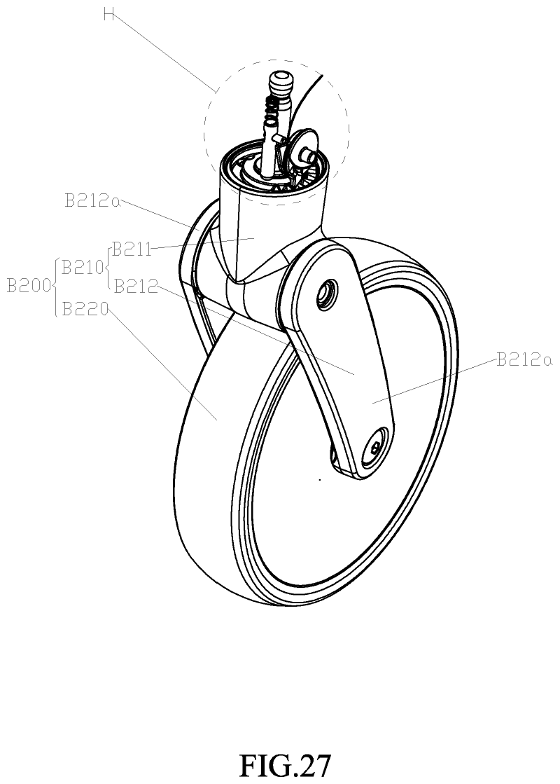

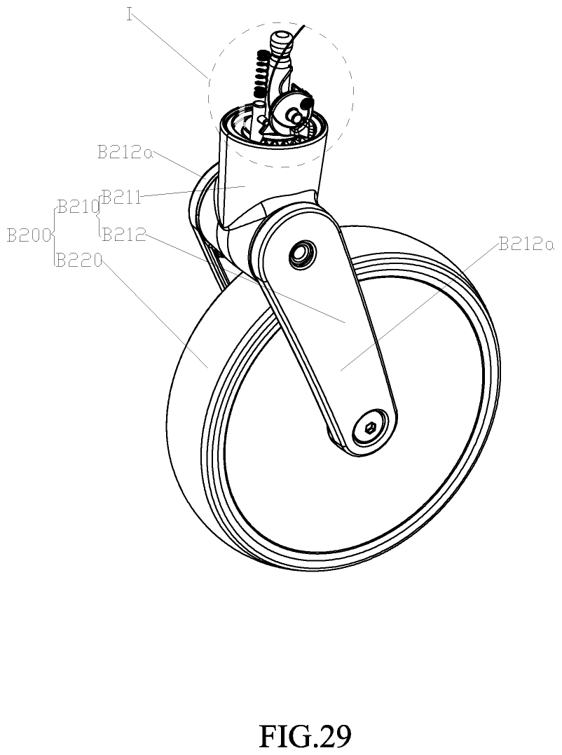

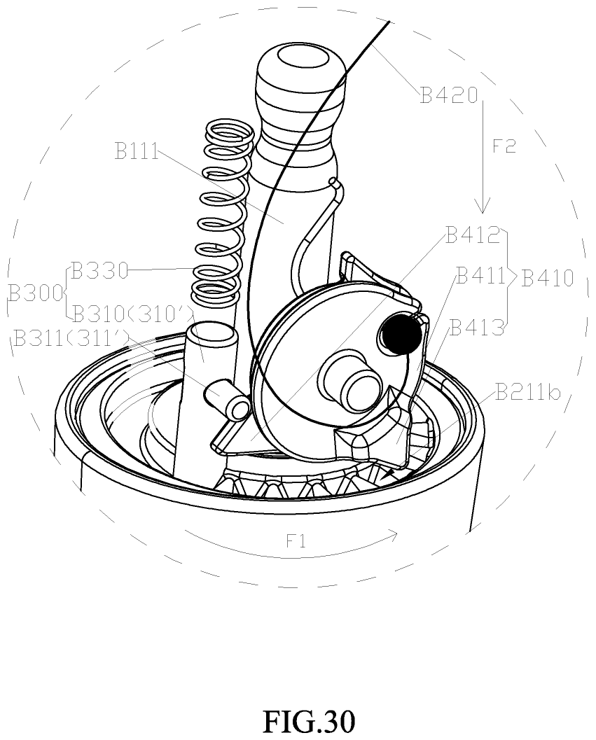

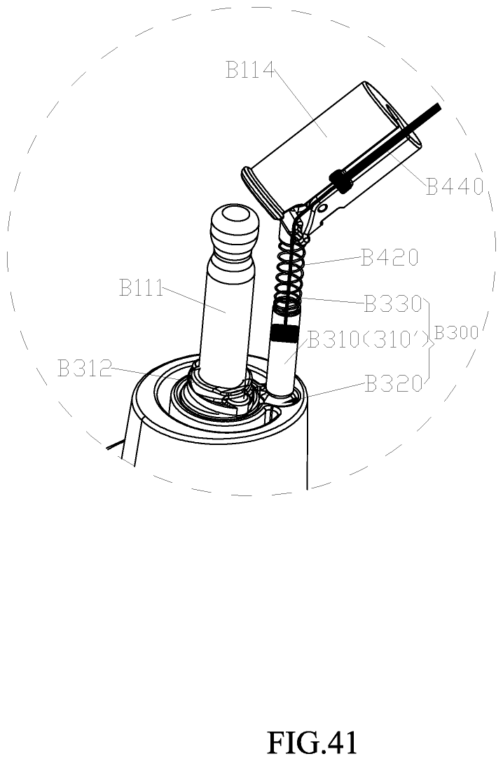

In details, as shown in FIG. 14, and FIGS. 27 to 30, the orientation assembly B300 includes an orientation element B310, an orientation slot B320, and a first reset member B330. In this embodiment, the orientation element B310 is movably arranged at the frame body B100. In this embodiment, the orientation element B310 is movably arranged at the pedal B160, and the orientation element B310 may move to protrude from a bottom surface of the pedal B160. The orientation assembly B310 is, for example, an orientation pin B310′, as shown in FIG. 22. Furthermore, as shown in FIGS. 28 and 30, an abutting and pushing element B311 is fixed to a side of the orientation pin B310′, and the abutting and pushing element B311 is, for example, an abutting and pushing pin B311′. As shown in FIG. 14, the orientation slot B320 is arranged at the connecting seat 211 and at a position different from the pivot hole B211a, e.g., at a position offset from a rotation center of the wheel seat B210. The orientation pin B310′ may be inserted into the orientation slot B320 when the connecting seat 211 rotates to a preset position with respect to the front leg support rod B110, i.e., when the connecting seat 211 rotates to a position where the orientation pin B310′ is opposite to the orientation slot B320. In this embodiment, as shown in FIG. 41, an end of the orientation pin B310′ for being inserted into the orientation slot B320 is provided with a chamfer structure B312, and the orientation slot B320 has a flared structure, i.e., an inner diameter of the orientation slot B320 near its opened end is larger than that near its bottom end. Such arrangement may facilitate the insertion of the orientation pin B310′ into the orientation slot B320. Two ends of the first reset member B330 respectively abut against the pedal B160 and the orientation pin B310′, and the first reset member B330 always moves the orientation pin B310′ in a direction close to the wheel seat B210. Optionally, the first reset member B330 is a spring.

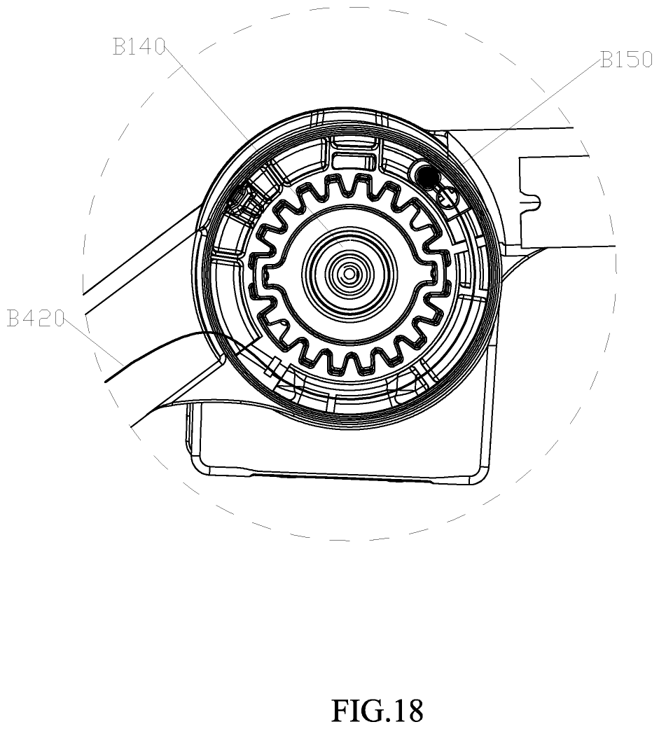

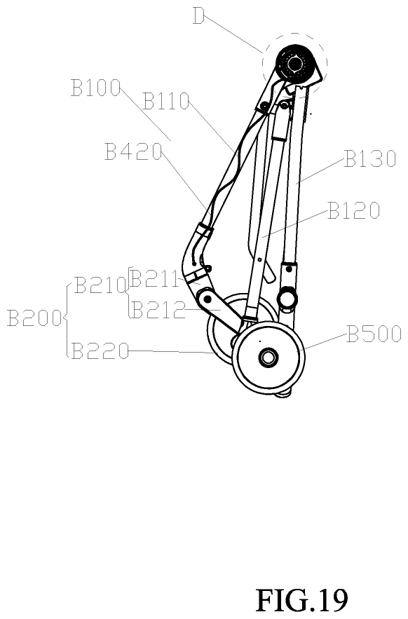

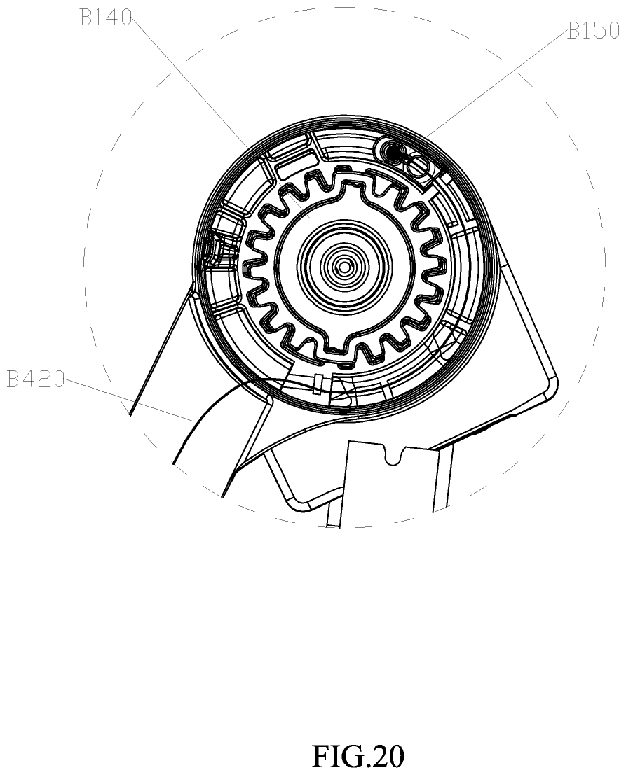

In details, as shown in FIGS. 28, 30, and 36, the driving assembly B400 includes a driving member B410, a dragging part (i.e. dragging member) B420, and a second reset member B430. In this embodiment, the driving member B410 is rotatably arranged at the pedal B160. The driving member B410 specifically includes a turntable B411 and a transmission tooth B412 and a driving tooth B413 arranged on the turntable B411 at intervals. In this embodiment, the driving member B410 has an integrated structure. Of course, in other embodiments, the driving member B410 may also be formed by connecting the turntable B411, the transmission tooth B412, and the driving tooth B413 which are independent to each other. The transmission tooth B412 is located at a side of the abutting and pushing pin B311′ close to the wheel seat B210, i.e., at the lower side of the abutting and pushing pin B311′. In this embodiment, the dragging part B420 is a steel wire. As shown in FIGS. 18 to 20, one end of the dragging part B420 is connected to the fixing members B150, and as shown in FIGS. 28 and 30, the other end of the dragging part B420 is connected to the turntable B411, moreover, the connection point between the dragging part B420 and the turntable B411 is offset from a rotation center of the turntable B411. As shown in FIG. 10, the dragging part B420 is tightened when the frame body B100 is in the unfolded state. As shown in FIG. 11, the frame body B100 is in the folded state, and the dragging part B420 is loosened.

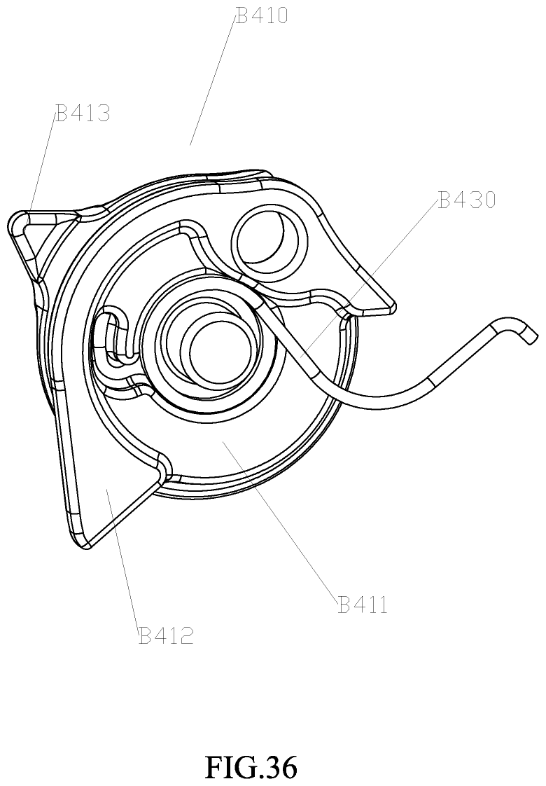

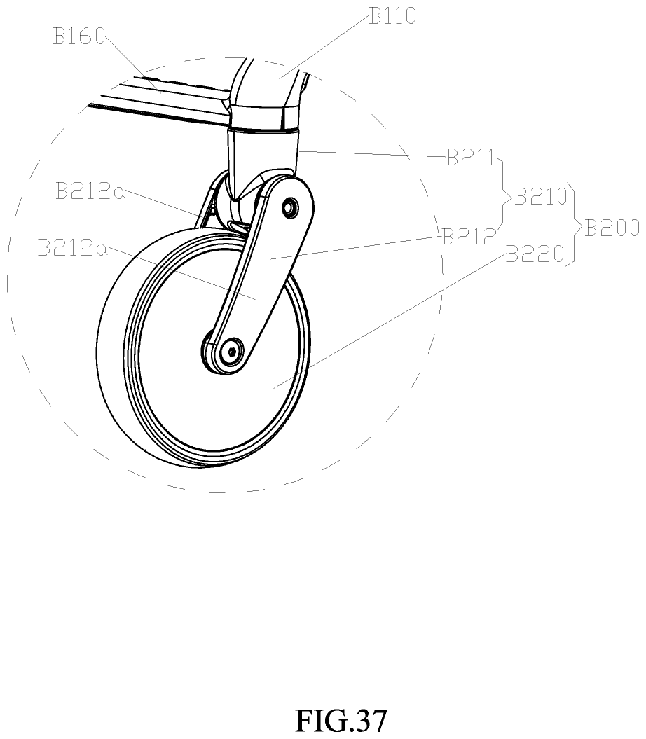

Further, as shown in FIGS. 28 and 30, the driving member B410 has a first rotational position and a second rotational position. The driving member B410 is rotated to the first rotational position when the dragging part B420 is tightened, and the transmission tooth B412 push the orientation pin B310′ along a direction away from the wheel seat B210 until it leaves the orientation slot B320, as shown in FIG. 28. The driving member B410 is rotated to the second rotational position without pushing the orientation pin B310′ along the direction away from the wheel seat B210 when the dragging part B420 is loosened, as shown in FIG. 30. As shown in FIG. 36, two ends of the second reset member B430 are respectively abutted against the pedal B 160 and the turntable B411, and the second reset member B430 always rotates the driving member B410 to the second rotational position.

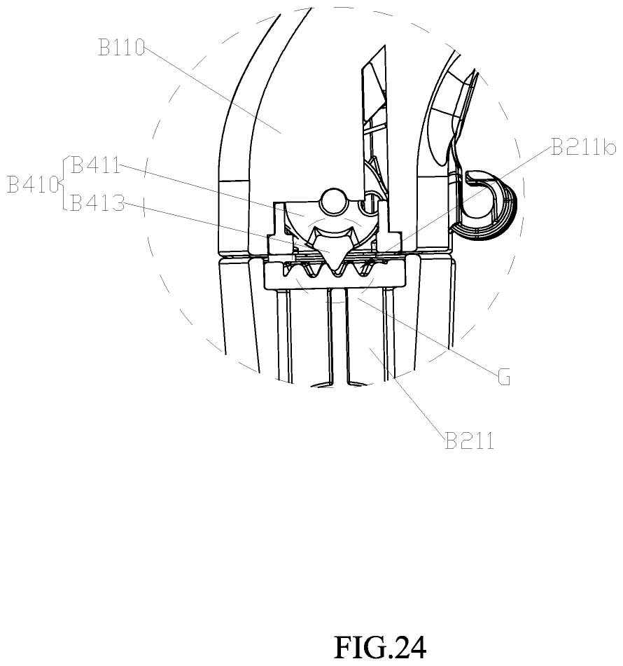

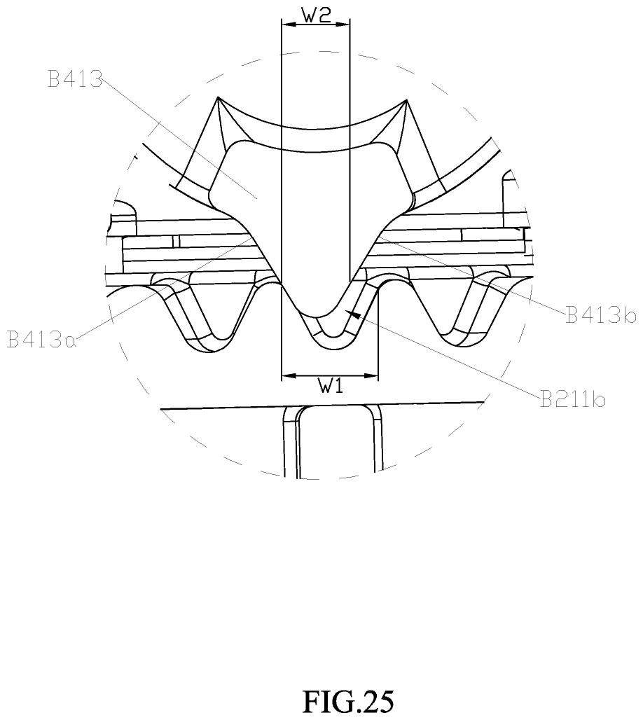

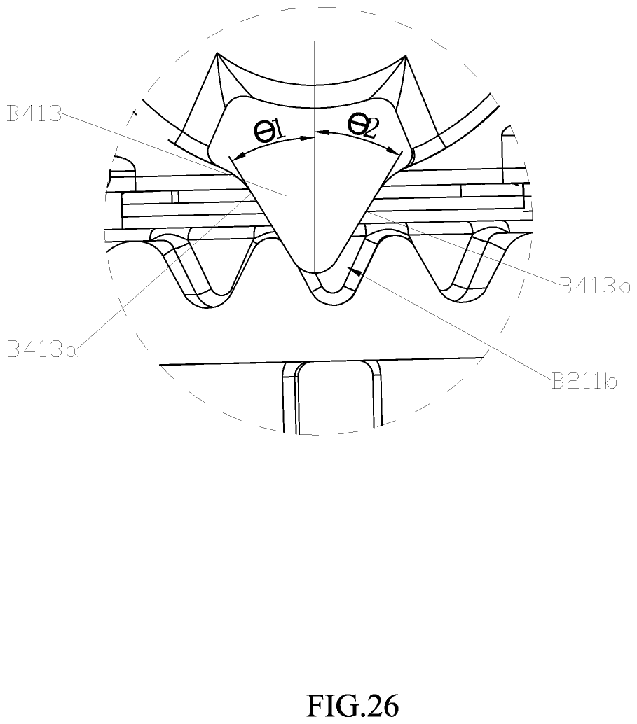

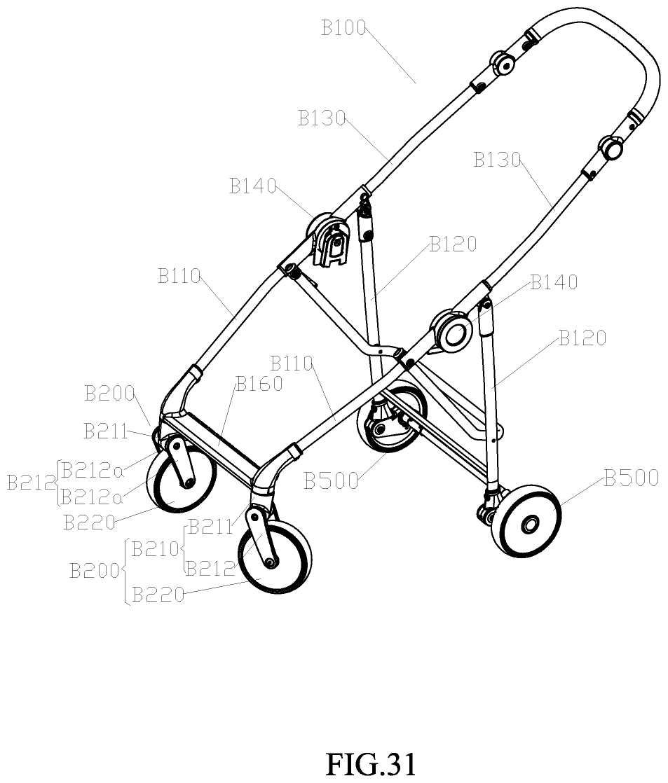

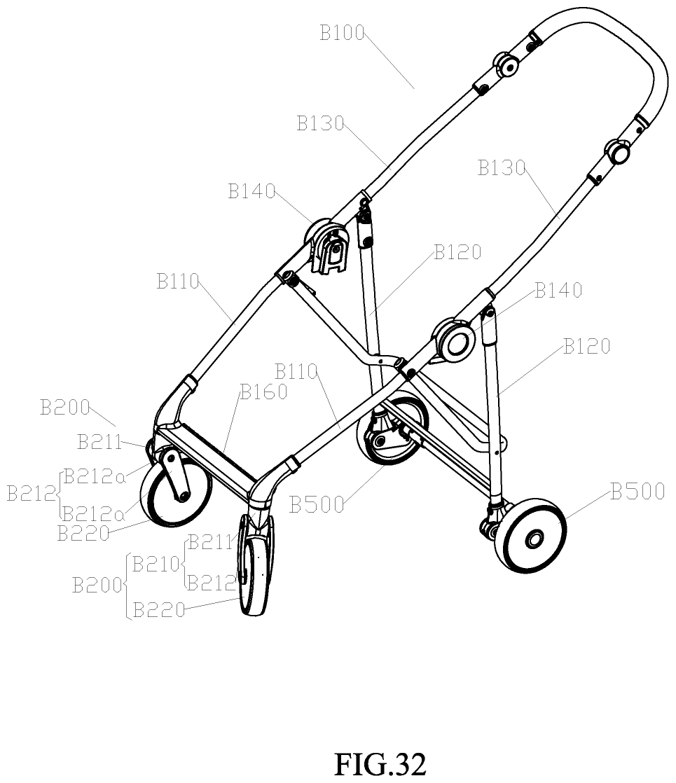

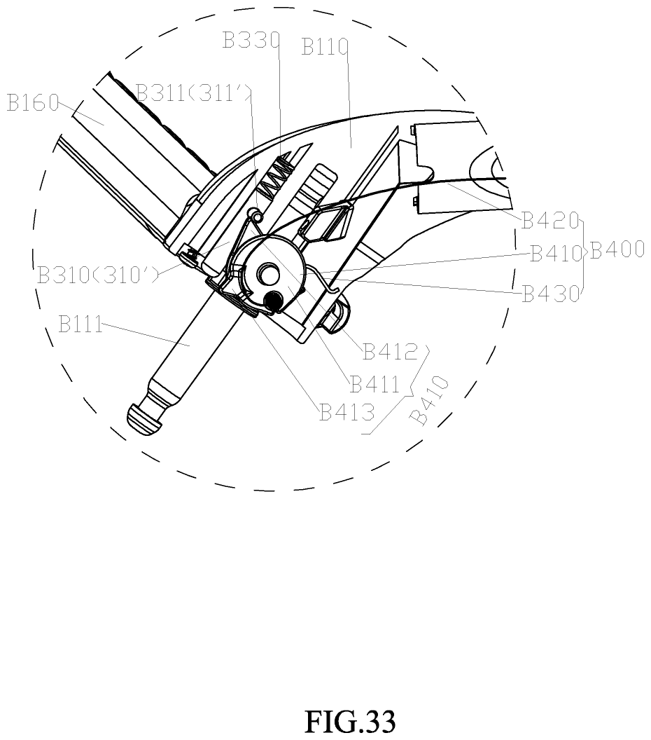

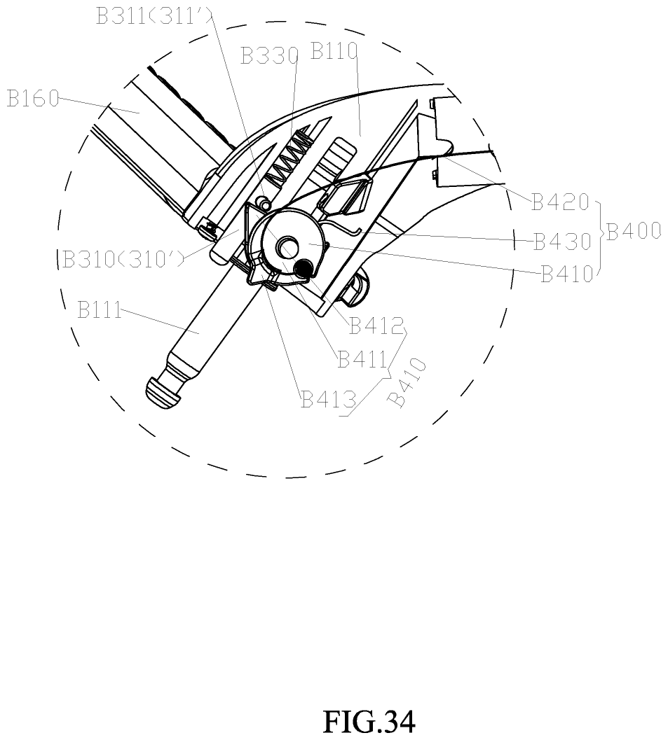

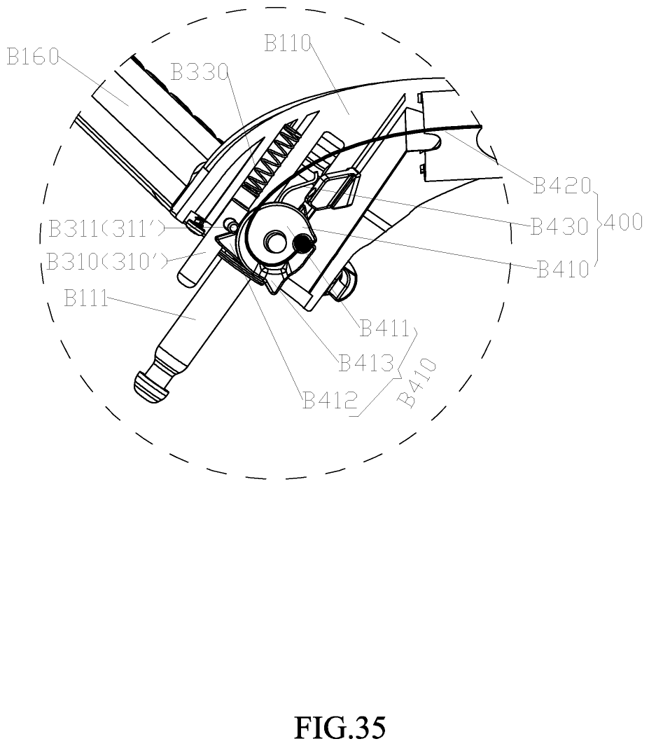

Further, as shown in FIGS. 28 and 30, a surface of the connecting seat 211 facing the pedal B160 is annularly provided with a plurality of tooth slots B211b which may be cooperating with the driving tooth B413. The driving tooth B413 may abut against a slot wall of any corresponding tooth slot B211b to drive the wheel seat B210 to rotate when the driving member B410 is rotated. As shown in FIGS. 24 to 26, the driving tooth B413 abuts against one face of the tooth slot B211b and has a gap with the other face when the driving tooth B413 is inserted into any tooth slot B211b, accordingly, the driving tooth B413 will not be stuck in a certain tooth slot B211b, but will push against a slot wall of a different tooth slot B211b following rotation of the driving member B410, so as to drive the wheel seat B210 to rotate. There are various ways to provide a gap between the driving tooth B413 and the tooth slot B211b. For example, as shown in FIG. 25, the maximum width W1 of the tooth slot B211b may be set to be greater than the maximum width W2 of the portion where the driving tooth B413 is inserted into the tooth slot B211b. Alternatively, as shown in FIG. 26, the driving tooth B413 may also include a first bevel edge B413a and a second bevel edge B413b which are arranged at an included angle. The first bevel edge B413a or the second bevel edge B413b may abut against the slot wall of any corresponding tooth slot B211b, and the inclination angle θ1 of the first bevel edge B413a is larger than the inclination angle θ2 of the second bevel edge B413b, or the inclination angle θ1 of the first bevel edge B413a s smaller than the inclination angle θ2 of the second bevel edge B413b. So, there will be a gap between the first bevel edge B413a or the second bevel edge B413b and the slot wall of any corresponding tooth slot B211b, and the wheel seat B210 may be rotated by the first bevel edge B413a or the second bevel edge B413b pushing against the slot wall of a different tooth slot B211b. A central angle of the annular region of the plurality of tooth slots B211b may also be 90°-360°. In this embodiment, as shown in FIG. 14, the central angle θ3 of the annular region of the plurality of tooth slots B211b is 30°-180°, that is, the central angle θ3 from the tooth slot B211b at “M” to the tooth slot B211b at “N” is 30°-180°, such that the wheel seat B210 is rotated until the orientation pin B310′ is opposite to the orientation slot B320. In some embodiments, the central angle θ3 of the annular region of the plurality of tooth slots B211b is 106°, i.e., the central angle θ3 from the tooth slot B211b at “M” to the tooth slot B211b at “N” is 106°, in other words, the wheel seat B210 may be automatically rotated up to 106° under the cooperative driving of the driving tooth B413 and the tooth slots B211b when the foldable frame is in the folded state. For example, taking the wheel assembly B200 close to the left front leg support rods B110 as an example, the wheel assembly B200 is rotated from the state facing the left rear of the pedal B160 shown in FIG. 31 to the state that the wheel assembly B200 faces the left front of the pedal B160 shown in FIG. 32. If the wheel seat B210 has not been rotated such that the orientation pin B310′ is opposite to the orientation slot B320 at this time yet, then the wheel seat B210 may be rotated under its own folding inertia or external force such that the orientation pin B310′ is opposite to the orientation slot B320.

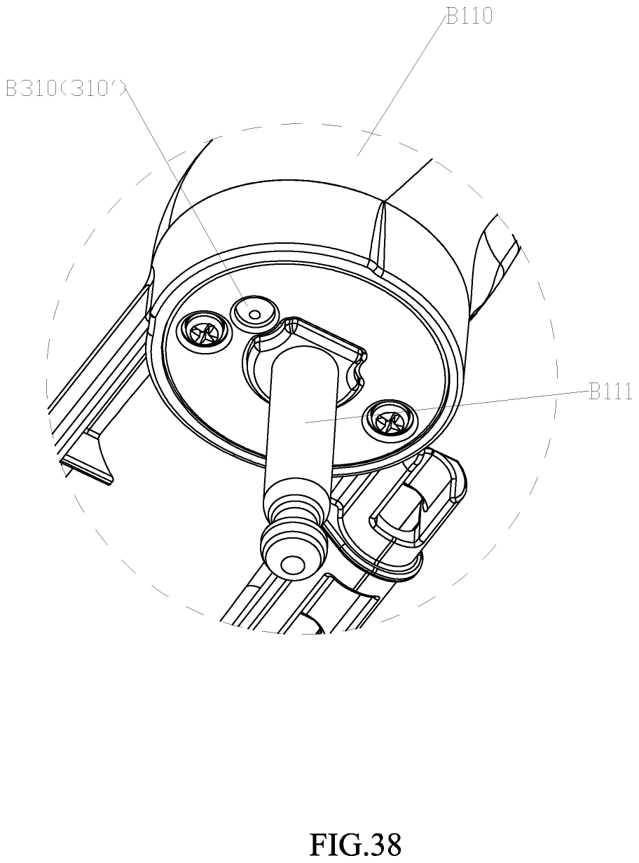

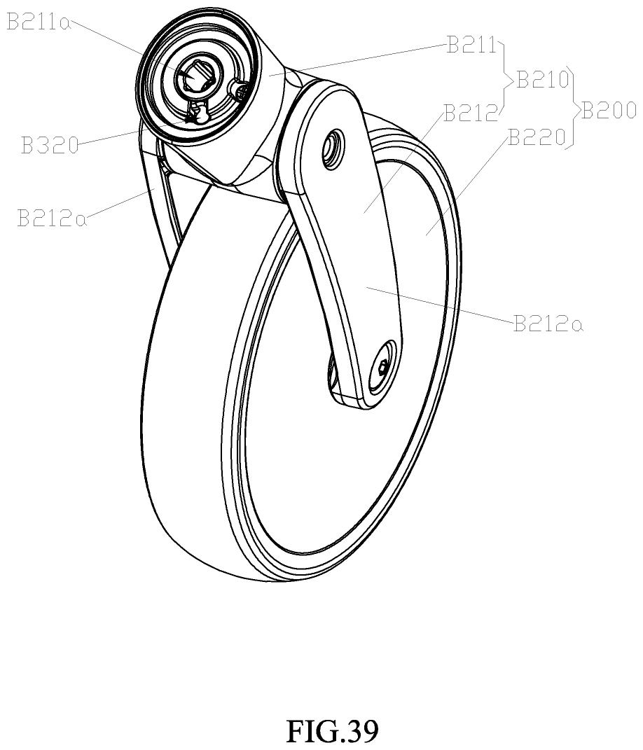

In another embodiment, as shown in FIGS. 38 and 39, the driving tooth B413 and the tooth slots B211b may be omitted as well, and the wheel seat B210 may be rotated purely by the inertia itself or external force of the wheel seat B210 such that the orientation pin B310′ is opposite to the orientation slot B320.

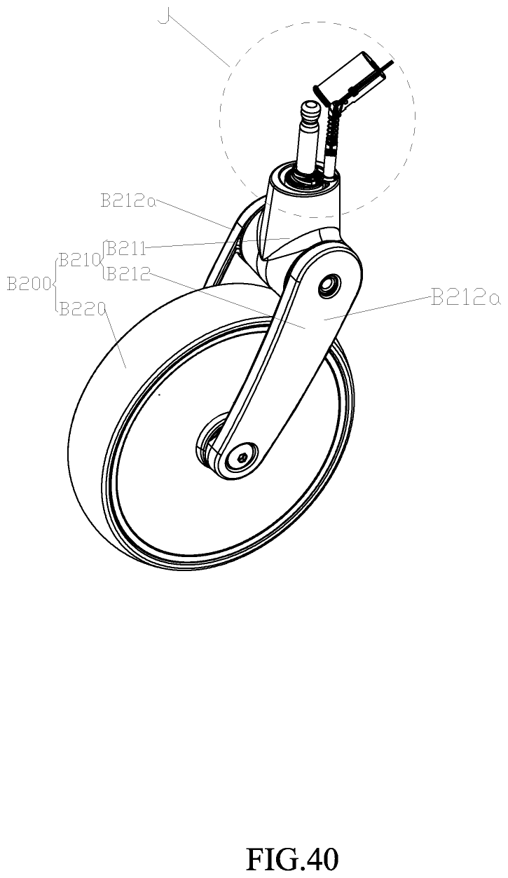

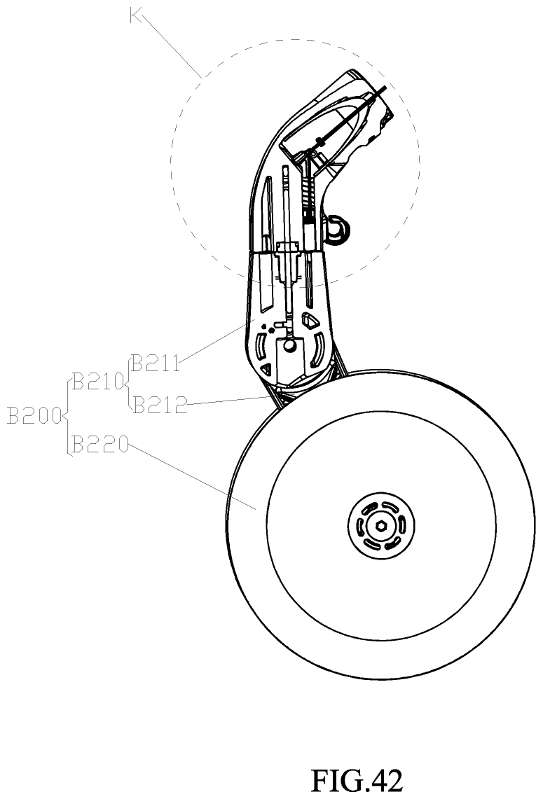

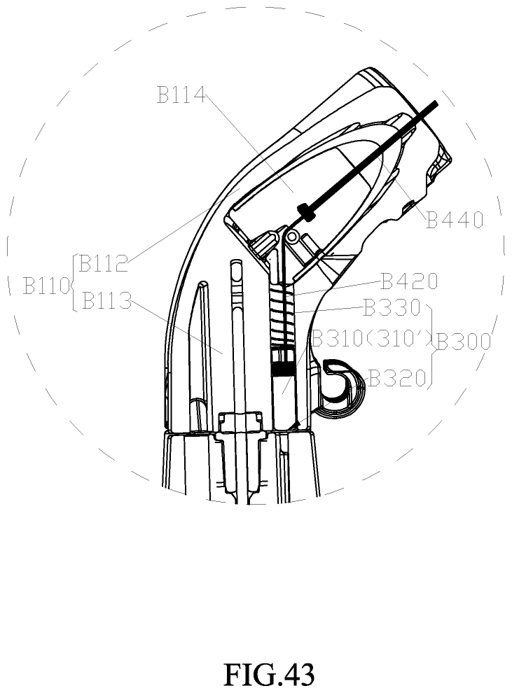

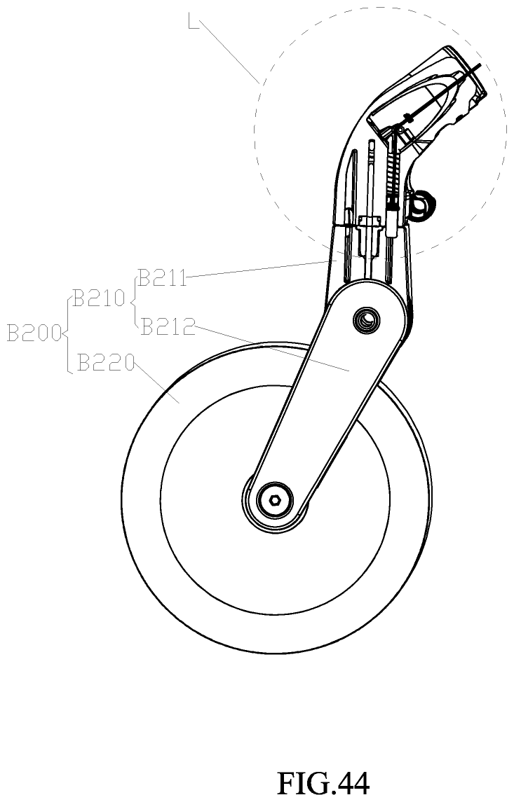

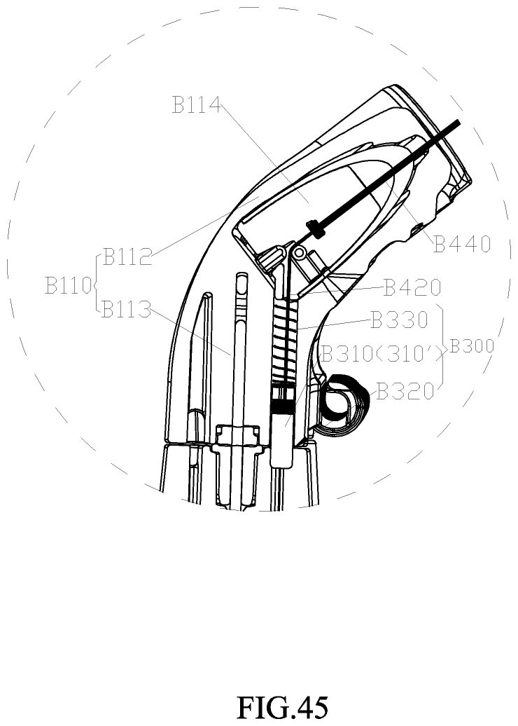

In a further embodiment, as shown in FIGS. 40 to 45, the driving tooth B413, the tooth slots B211b, the driving member B410, and the second reset member B430 may all be omitted. At this time, one end of the dragging part B420 is connected to the fixing members B150 in FIG. 16, and the other end is directly connected to the orientation pin B310′. The dragging part B420 is tightened when the frame body B100 is in the unfolded state, such that the orientation pin B310 is always located at a position far away from the wheel seat B210. The dragging part B420 is loosened when the frame body B100 is in the folded state, and the orientation pin B310 moves in a direction close to the wheel seat B210 under action of the first reset member B330. In this embodiment, the front leg support rod B110 includes an inclined part B112 and a vertical part B113 which are connected to each other, and an end of the vertical part B113 away from the inclined part B112 is pivotably connected to the wheel seat B210 through the rotation shaft B111. An inner plug element B114 is arranged inside the inclined part B112, and a pulley B115 is arranged on the inner plug element B114. In this embodiment, the pulley B115 is roughly located at a connection between the inclined part B112 and the vertical part B113. One end of the dragging part B420 is connected to the fixing members B150, and the other end is connected to the orientation pin B310′ by passing through the inner plug element B114 and rounding on the pulley B115. That is, the part of the dragging part B420 located inside the inclined part B112 is obliquely arranged along the same direction as the inclined part B112, and the part of the dragging part B420 located inside the vertical part B113 is vertically arranged along the same direction as the vertical part B113 after changing direction rounding the pulley B115, i.e., the dragging part B420 in this part is arranged in the same direction as the orientation pin B310′. In this way, the orientation pin B310′ may be dragged along the vertical direction, such that make the force on the orientation pin B310′ more uniform. Of course, in other embodiments, the pulley B115 or the inner plug element B114 may also be omitted. Furthermore, the driving assembly B400 may further include a sheath B440. The sheath B440 is sleeved on the part of the dragging part B420 located inside the inclined part B112, so as to provide an accommodating channel for the dragging part B420, and simultaneously play a protection role for the dragging part B420.

The use process of the foldable frame will be specifically described as follows:

When the foldable frame is in the unfolded state, as shown in FIG. 10, the dragging part B420 is tightened, and the dragging part B420 pulls the driving member B410 to make the driving member B410 in the first rotational position, such that the transmission tooth B412 on the driving member B410 push against the abutting and pushing pin B311′ close to a side of the wheel seat B210, i.e., the lower side of the abutting and pushing pin B311′, such that the orientation pin B310′ is separated from the orientation slot B320, and the wheel seat B210 may be rotated freely with respect to the pedal B160 and the front leg support rod B110, which is convenient for the child stroller to be steered freely while being pushed, as shown in FIG. 28.

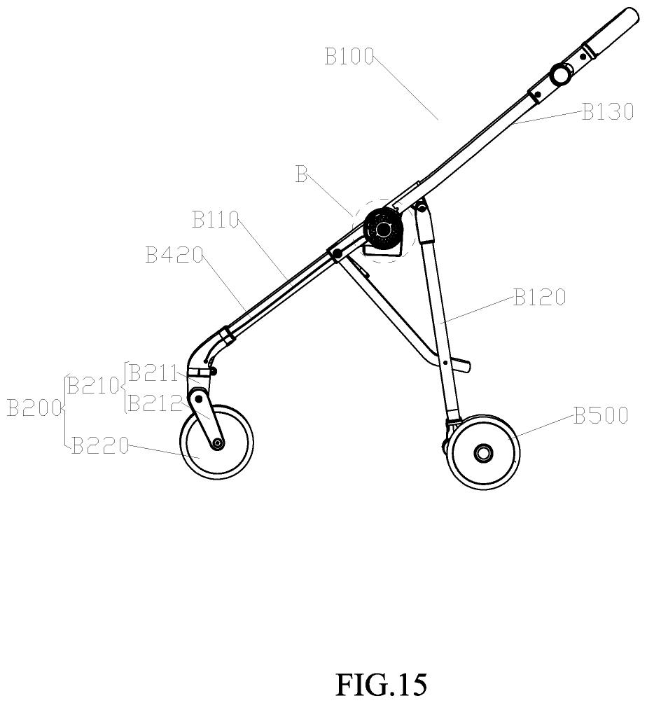

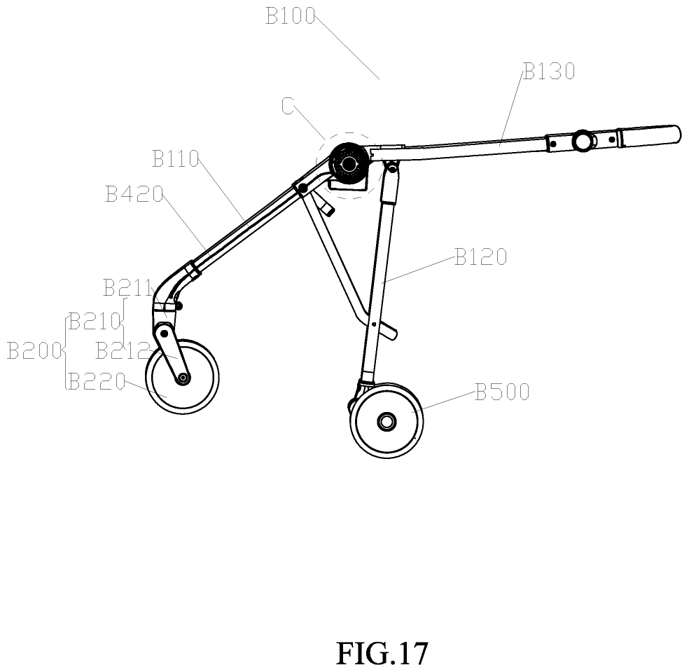

When the foldable frame is in the folded state, as shown in FIG. 11, the foldable joint B140 is rotated, such that the position of the fixing members B150 is closer to the wheel seat B210, and as shown in FIGS. 15 to 20, the originally tightened dragging part B420 becomes loosen and loses the pulling effect on the driving member B410, then the driving member B410 is rotated in the counterclockwise direction shown in FIG. 28 toward the second rotational position the under the action of the second reset member B430. During the rotation process of the driving member B410, the driving tooth B413 sequentially pushes against the slot walls of different tooth slots B211b, so as to drive the wheel seat B210 to rotate along the F1 direction shown in FIG. 28. Meanwhile, during the rotation process of the driving member B410, the transmission tooth B412 no longer pushes against the abutting and pushing pin B311′ in the direction away from the wheel seat B210, and then, after the abutting and pushing pin B311′ loses the pushing action of the transmission tooth B412, the orientation pin B310′ moves in the direction close to the wheel seat B210 under the action of the first reset member B330. When the driving member B410 is rotated to the second rotational position, the orientation pin B310′ is inserted into the orientation slot B320 and is opposite to the orientation slot B320, such that the wheel assembly B200 and the frame body B100 are relatively fixed at the preset position, as shown in FIG. 30. In the preset position, the foldable frame in the folded state may stand stably on the ground, thus facilitating to be placed vertically by consumers, moreover, the wheel assembly B200 and the transmission wheel B500 respectively connected to the front leg support rod B110 and the rear leg support rod B120 are partially or completely coincident, which greatly saves the storage space.

The above child stroller and the foldable frame at least have the following technical effects:
In the foldable frame, the orientation assembly B300 is unlocked when the frame body B100 is in the unfolded state, such that the wheel assembly B200 may be rotated with respect to the frame body B100, thereby facilitating steering of the foldable frame. The driving assembly B400 may drive the orientation assembly B300 to be locked when the frame body B100 is in folded state, such that the wheel assembly B200 and the frame body B100 may be relatively fixed at a preset position, for example, at the position where the wheel assembly B200 is located when the foldable frame advances linearly, so, the foldable frame in the folded state may stand stably on the ground, thus facilitating to be placed vertically by consumers and greatly saving the storage space.

### Third Embodiment

In this embodiment, a child stroller is taken as an example as well. However, the wheel orientation mechanism according to this embodiment may also be used in other child devices requiring to lock the wheels, such as highchairs, and may also be used in other devices such as wheelchairs for the disabled.

The wheel orientation mechanism C10 according to this embodiment is also arranged to enable the wheel seat C32 of a wheel C30 to be rotationally locked when the child stroller C1 is in a folded state, such that the child stroller C1 in the folded state may be stably stored upright, thus improving convenience of the child stroller C1 in use. Moreover, the wheel orientation mechanism C10 according to this embodiment may unlock the wheel seat C32 from the locked state when the child stroller C1 is in an unfolded state, such that the wheel C30 may rotate freely.

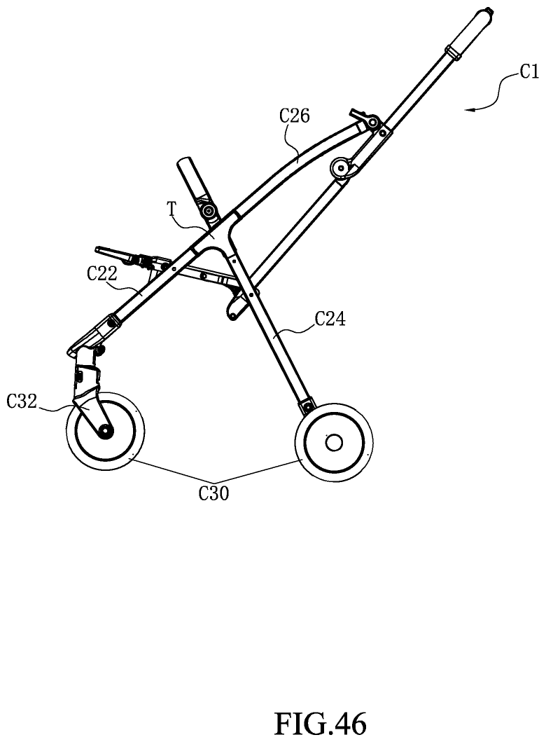

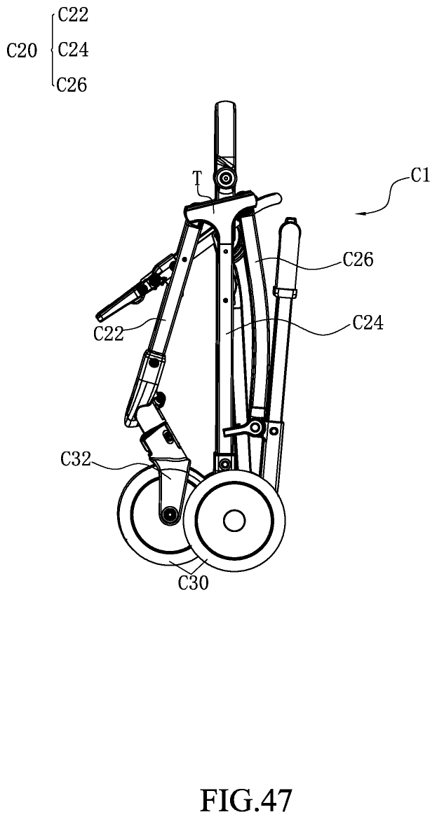

Hereinafter, a child stroller C1 according to this embodiment will be described with reference to FIGS. 46 and 47, in which FIG. 46 is a schematic view showing the child stroller C1 according to another embodiment of the application, and the child stroller C1 shown in FIG. 46 is in an unfolded state; FIG. 47 is a schematic view showing the child stroller C1 according to another embodiment of the application, and the child stroller C1 shown in FIG. 47 is in a folded state. The child stroller C1 according to this embodiment includes a frame C20 and wheels C30. The frame C20 includes a front leg C22, a rear leg C24 and a handlebar assembly. As shown in FIG. 46, the rear leg C24 is provided with a pivot joint T. The pivot joint T has a lower end pivoted to the front leg C22 of the frame, and an upper end pivoted to the handlebar assembly of the frame. According to one of the embodiments, the pivot joint T is T-shaped and oriented as shown in FIG. 46, the left-lower end of the pivot joint T is connected to the front leg C22, the right-lower end of the pivot joint T is connected to the rear leg C24, and the right-upper end of the pivot joint T is connected to the handlebar assembly, so the handlebar assembly, the front leg C22, and the rear leg C24 may be pivotally connected at the pivot joint T, such that the handlebar assembly, the front leg C22, and the rear leg C24 may be folded with respect to each other, so as to reduce the volume of the child stroller C1 when it is temporarily not used. Of course it is not limited to this. The handlebar assembly may include a handlebar linkage part C26, and correspondingly, the handlebar linkage part C26, the front leg C22, and the rear leg C24 are pivotally connected to each other at the pivot joint T, and the right upper end of the pivot joint T is connected to the handlebar linkage part C26. The wheels C30 usually include a set of front wheels and a set of rear wheels, and each of the wheels includes a wheel seat C32. The front leg C22 of the child stroller C1 is connected to the wheel seats of the front wheels, and the rear leg C24 of the child stroller C1 is connected to the wheel seats of the rear wheels. In the following description, take the locking part C200 of the wheel orientation mechanism C10 is provided on the front wheels as an example, but it is not limited to this.

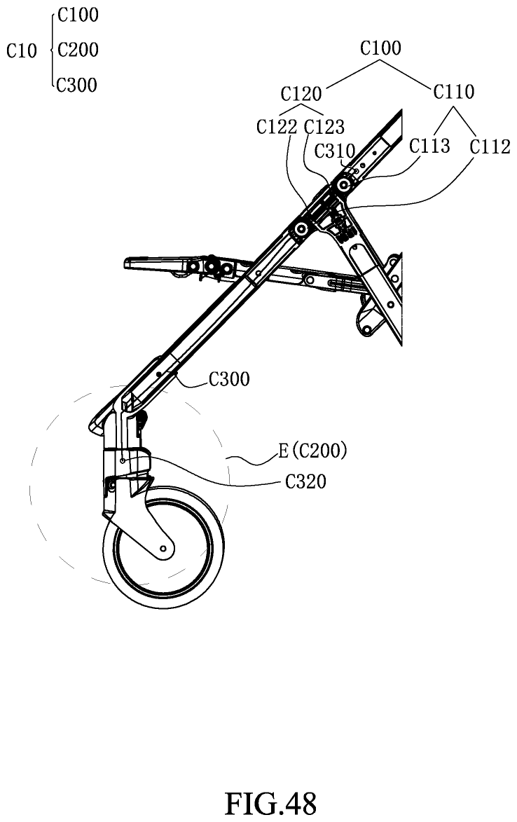

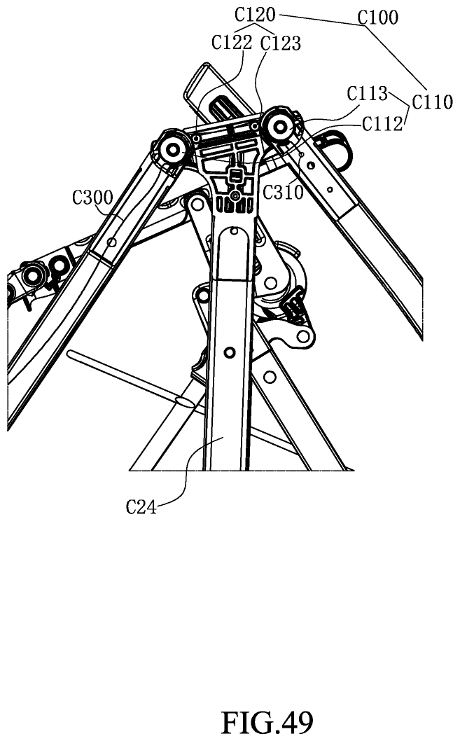

Next, the wheel orientation mechanism C10 according to this embodiment will be described with reference to FIGS. 48 and 49, in which FIG. 48 is a schematic view showing the wheel orientation mechanism C10 according to the application, a driving guide part C100 and a locking part C200 of the wheel orientation mechanism C10 are shown in FIG. 48, and the child stroller C1 shown in FIG. 48 is in an unfolded state; FIG. 49 is a schematic view showing the wheel orientation mechanism C10 according to the application, the driving guide part C100 and the locking part C200 of the wheel orientation mechanism C10 are shown in FIG. 49, and the child stroller C1 shown in FIG. 49 is in a folded state. The wheel orientation mechanism C10 according to this embodiment mainly includes a driving guide part C100, a locking part C200, and a dragging part C300 connecting the driving guide part C100 and the locking part C200. As shown in FIG. 48, the dragging part C300 includes a first end C310 and a second end C320. The first end C310 of the dragging part C300 is connected to the handlebar linkage part C26, and the second end C320 of the dragging part C300 is connected to the locking member C210 of the locking part C200, such that a corresponding action of the locking member C210 may be caused via the dragging part C300 by folding and unfolding of the handlebar assembly with respect to the front leg C22.

In details, in the embodiment shown in FIGS. 48-50, the driving guide part C100 includes a pulley group C110 and a guide post group C120. The pulley group C110 and the guide post group C120 are arranged along a moving path of the dragging part C300. More specifically, the pulley group C110 further includes a first pulley C112 and a second pulley C113, and the guide post group C120 further includes a first guide post C122 and a second guide post C123. As shown in FIGS. 48 and 49, the first end C310 of the dragging part C300 is connected to the handlebar linkage part C 26 after passing through the first pulley C112, the first guide post C122, the second guide post C123, and the second pulley C113 in turn. Of course, other ways for winding the dragging part C300 are also feasible. In the embodiment shown in FIGS. 48 and 49, the first pulley C112 and the second pulley C113 are respectively distributed on upper and lower sides of the pivot joint T, and the first guide post C122 and the second guide post C123 are also respectively distributed on upper and lower sides of the pivot joint T. The first pulley C112 is arranged at the pivot connection between the pivot joint T and the front leg C22, and the second pulley C113 is arranged at the pivot connection between the pivot joint T and the handlebar linkage part C26. The distance between the first guide post C122 and the second guide post C123 in the extending direction of the front leg C22 is smaller than the distance between the first pulley C112 and the second pulley C113 in the extending direction of the front leg C22. The first end C310 of the dragging part C300 is connected to the handlebar assembly after passing through the lower edge of the first pulley C112, the upper edge of the first guide post C122, the upper edge of the second guide post C123, and the lower edge of the second pulley C113 in turn. Thus, the dragging part C300 may be loosened when the handlebar assembly is folded with respect to the front leg C22, and the dragging part C300 may be tightened when the handlebar assembly is unfolded with respect to the front leg C22. The application is not limited to the arrangements of the pulley group C110 and the guide post group C120 shown in the above embodiment, and other arrangements are also feasible, as long as the dragging part C300 may be loosened and tightened through folding and unfolding of the handlebar assembly with respect to the front leg C22.

According to an embodiment of the application, both the first pulley C112 and the second pulley C113 are fixed pulleys, and both the first guide post C122 and the second guide post C123 are fixed posts. Of course, the first pulley C112, the second pulley C113, the first guide post C122, and the second guide post C123 may all be fixed pulleys, and may all be fixed posts, and the dragging part C300 is a steel wire.

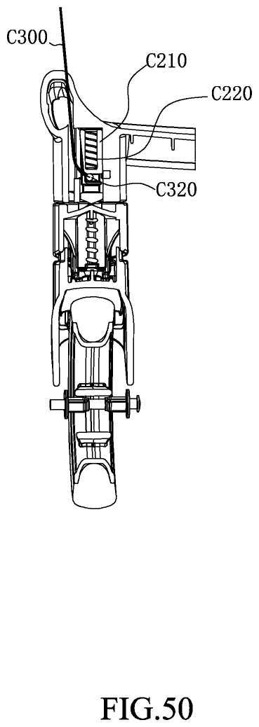

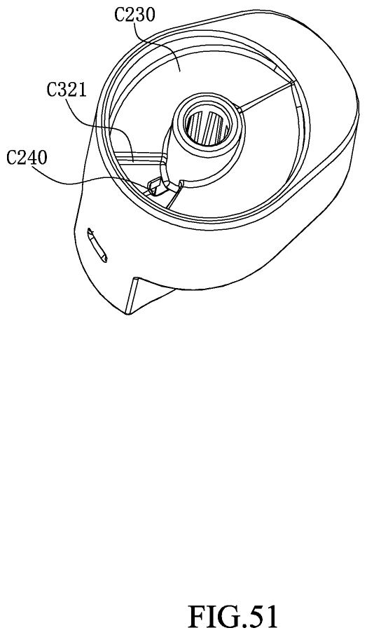

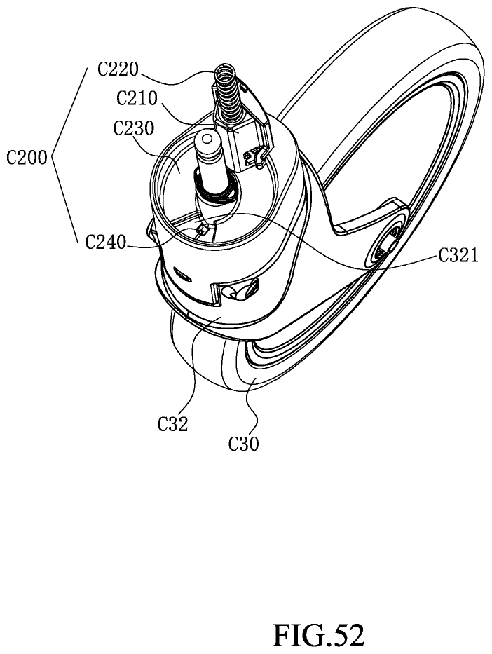

Next, the detailed structure of the locking part C200 will be described with reference to FIGS. 50, 51, and 52, in which FIG. 50 is a schematic view showing the part “E” in FIG. 48 from another view; FIG. 51 is a schematic view showing a rotating part C230 and a locking hole C240 according to the embodiment of the application; and FIG. 52 is a schematic view showing a locking part C200 according to the embodiment of the application. Referring back to FIG. 48, the second end C320 of the dragging part C300 is connected to the locking part C200 shown in the part “E” in FIG. 48, and FIG. 50 is a schematic view showing the part “E” from another view. The locking part C200 mainly includes a locking member C210 and a locking hole C240, and the locking member C210 may enter and leave the locking hole C240. Referring to FIG. 51, the locking part C200 further includes a rotating part C230 and an elastic member C220, and the elastic member C220 abuts on and pushes the locking member C210 to cause the locking member C210 to fall when the frame C 20 is folded. After the locking member C210 falls down, it will abut and push the rotating part C230, such that the locking hole C240 is rotated to align with the locking member C210 for locking. According to an embodiment, the locking member C210 is locked into the locking hole C240 after the wheel is rotated 180° through the rotating part C230, but the invention is not limited to the above rotation angle, rather, the rotation angle of the wheel C30 may be set according to actual requirements. Both the rotating part C230 and the locking hole C240 are arranged on an end face C321 of the of wheel seat C32 of the wheel C30 facing to the frame C20. According to the embodiment shown in FIG. 51, the rotating part C230 is a spiral surface of the wheel C30, the locking hole C240 is also arranged on the end face C321 of the wheel seat C32, and a lowest point of the spiral surface is arranged to be spaced from the locking hole C24. For example, the locking hole C240 is located below the lowest point of the spiral surface, and according to an embodiment, a stepped surface is arranged between the lowest point of the spiral surface and the locking hole C240. Thus, as shown in FIG. 52, in case that the locking member C210 abuts on the rotating part C230, if the locking member C210 moves downwardly along the rotating part C230 which is in form of the spiral surface, the locking member 210 may exert a tangential force to the rotating part C230 along the spiral surface, which may bring the wheel seat C32 and the wheel C30 to rotate together. According to the embodiment shown in FIG. 51, the locking member C210 will continue to move downwardly to be inserted into the locking hole C240 after rotating an angle.

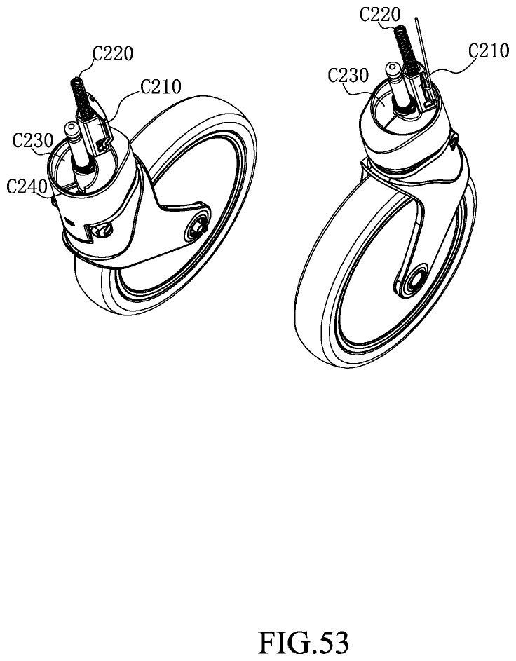

Hereinafter, actions of the driving guide part C100 and the locking part C200 during unfolding operation of the child stroller C1 according to this embodiment will be described with reference to FIGS. 48 and 53, in which FIG. 53 is a schematic view showing different positional relationships of the locking part C200 according to the embodiment when the child stroller C1 is in the unfolded state and the folded state. The first end C310 of the dragging part C300 is tightened around a lower edge part of the first pulley C112, an upper edge part of the first guide post C122, an upper edge part of the second guide post C123, and a lower edge part of the second pulley C113 in turn when the handlebar assembly is in the unfolded state with respect to the front leg C22, and the second end C320 of the dragging part C300 will correspondingly pull up the locking member C210 to leave the locking hole C240, moreover, the pulling up action of the locking member C210 will make the elastic member C220 connected to the locking member C210 in a compressed state. In such state, the wheels C30 may rotate freely without obstacles, and the child stroller C1 may be easily pushed.

Next, actions of the driving guide part C100 and the locking part C200 during folding operation of the child stroller C1 according to this embodiment will be described with reference to FIGS. 49 and 53. In case that the handlebar assembly is folded with respect to the front leg C22, as shown in FIG. 49, the length of an arc of the first end C310 of the dragging part C300 contacting with the first pulley C112 and the second pulley C113 is reduced, and the dragging part C300 is thus loosened. At this time, the second end C320 of the dragging part C300, under driving of the elastic member C220, makes the locking member C210 move downwardly, and the locking member C210 moving downwardly pushes the rotating part C230 which is in form of a spiral surface, such that the wheels C30 rotate accordingly. After the wheels rotate a certain angle such that the front wheel is in a position roughly parallel to the rear wheel, the locking member C210 continues to move downwardly to be inserted into the locking hole C240, so as to lock the wheel seats C32 thereby locking the wheels C30, such that the child stroller C1 in the folded state may stand stably.

The pulley group C110 and the guide post group C120 according to this embodiment may also realize guiding of the dragging part C300, such that folding and unfolding operations may be performed smoother and more stable.

The wheel orientation mechanism C10 according to this embodiment is arranged to rotationally lock the wheel seats C32 of the wheels C30 in the folded state of the child stroller C1, such that the child stroller C1 in the folded state may be stably stored upright, thereby improving convenience of the child stroller in use. Moreover, in the unfolded state of the child stroller C1, the wheel orientation mechanism C10 according to this embodiment may unlock the locked state of the wheel seats C32, such that the wheels C30 may freely rotate without obstacles, which is convenient for pushing the child stroller C1.

### Fourth Embodiment

The structure of the child stroller D1 according to the fourth embodiment is similar to that of the child stroller C1 according to the third embodiment, so only the parts different from the third embodiment will be described hereinafter and the same contents will not be redundantly repeated here.

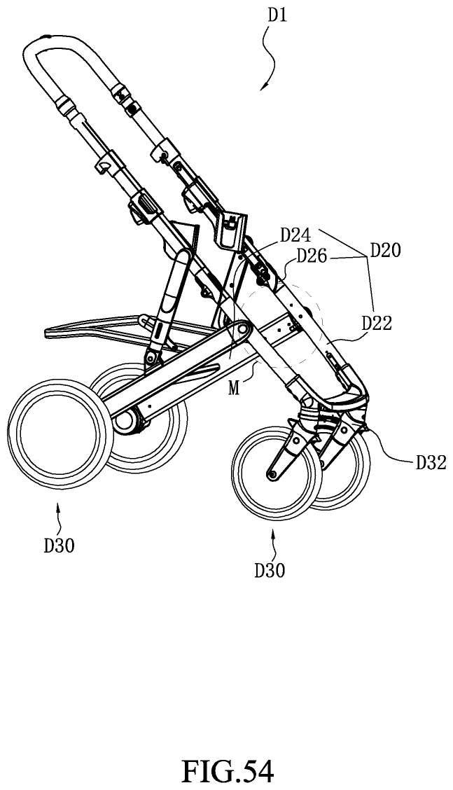

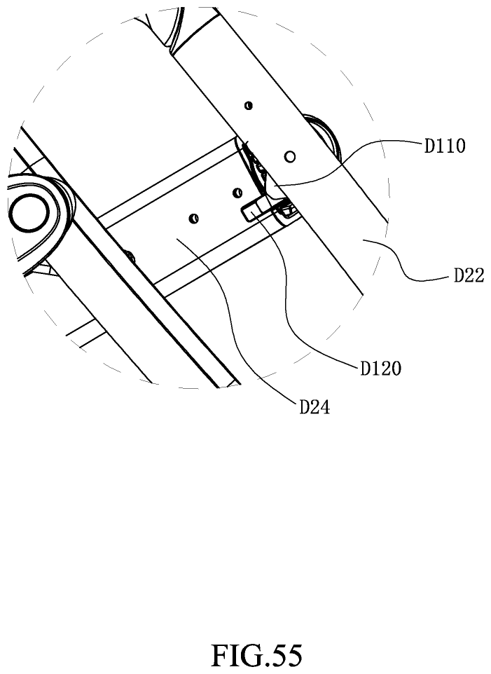

The following description will be illustrated with reference to FIGS. 54 and 55, in which FIG. 54 is a schematic view showing the child stroller D1 according to the fourth embodiment of the application, and FIG. 55 is an enlarged schematic view showing the part “M” of the child stroller D1 in FIG. 54. The wheel orientation mechanism according to this embodiment includes a driving part D100, a locking part D200, and a dragging part D300. The locking part D200 includes a locking member D210 and a locking hole D240. The dragging part D300 includes a first end D310 and a second end D320, with the first end D310 connected to the driving part D100, and the second end D320 connected to the locking member D210. The dragging part D300 will move to a second position by the driving part D100, along with an unfolding action of the frame D20, such that the locking member D210 leaves the locking hole D240 to be unlocked, and the dragging part D300 will move to a first position by the driving part D100, along with a folding action of the frame D20. The locking member D210 is inserted into the locking hole D240 to be locked when the dragging part D300 in the first position, and the locking member D210 leaves the locking hole D 240 to be unlocked when the dragging part D300 in the second position.

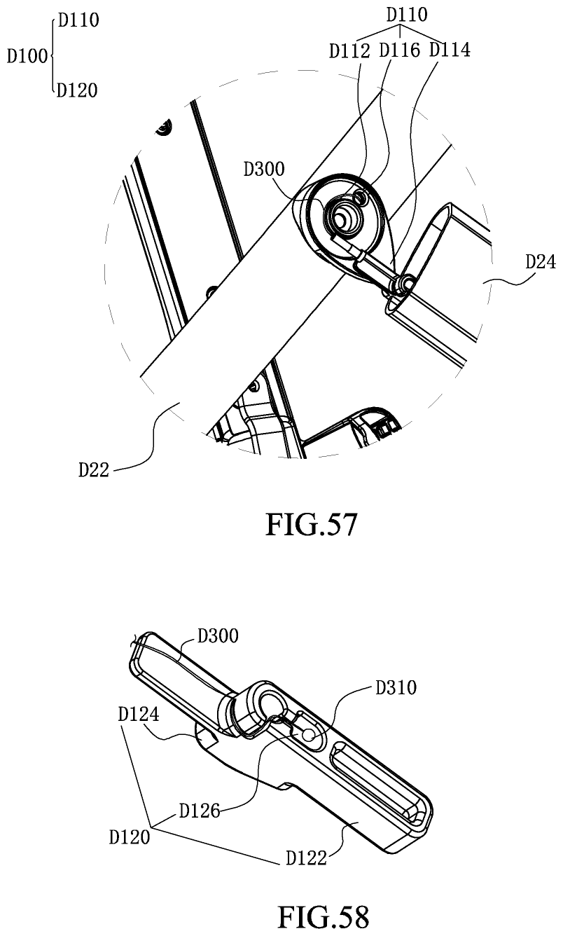

As shown in FIGS. 54 and 55, the driving part D100 according to this embodiment includes a pushing member D110 (as shown in FIG. 57) and a sliding member D120 (as shown in FIG. 58). According to the shown embodiment, the pushing member D110 is provided at a folding pivot joint of the frame D20, and the sling member D120 is also provided at a folding pivot joint of the frame D20, for example, the pushing member D110 is arranged at a front leg D22 of the frame D20, and the sliding member D120 is arranged at a rear leg D24 of the frame D20, but it is not limited to this. The pushing member D110 rotates correspondingly along with the unfolding or folding action of the frame D20, and the sliding member D120 linearly moves to and fro in a direction of force through pushing of the pushing member D110.

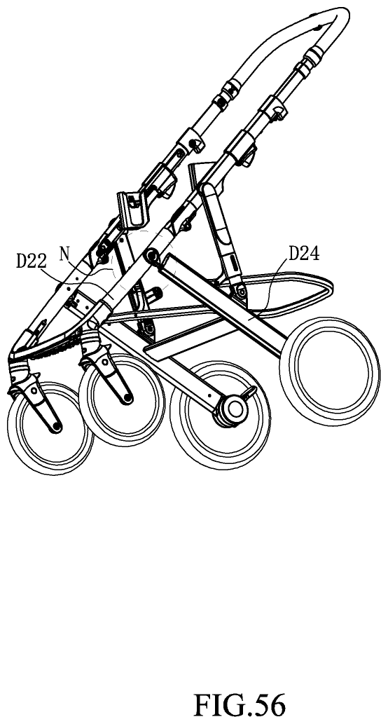

In details, the following description will be illustrated with reference to FIGS. 56 and 57, in which FIG. 56 is another schematic view showing the child stroller D1 according to the fourth embodiment of the application; and FIG. 57 is an enlarged schematic view showing the part “N” of the child stroller D1 in FIG. 56. As shown in FIG. 57, the pushing member D110 includes a pivot part D112, an abutting and pushing part D114, and a perforation part D116. The pushing member D110 will rotate counterclockwise or clockwise (with respect to FIG. 57) around the pivot part D112 when the frame D20 is unfolded or folded. The abutting and pushing part D114 is arranged at an end of the pushing member D110 and protrudes outward. the perforation part D116 is arranged adjacent to the pivot part D112.

Further, referring to FIG. 58. FIG. 58 is an enlarged schematic view showing the structure of the sliding member D120 according to the embodiment of the application. The sliding member D120 includes a sliding part D122, a protruding end D124, and an accommodating hole D126. The sliding part D122 always abuts and supports a tube of the rear leg, and slides along the tube of the rear leg when the sliding member linearly moves. An abutting end D114 of the pushing member D110 abuts against the protruding end D124 of the sliding member D120, such that the sliding member D120 will be brought to linearly move to and fro in the extending direction of the rear leg D24 when the pushing member D110 rotates. The first end of the dragging part D300 is fixed in the accommodating hole D126, and the position of the dragging part D300 may be changed along with the linear movement of the sliding member D120. After the first end D310 of the dragging part D300 is fixed in the accommodating hole D126, the other end of the dragging part D300, that is, the second end D320 surrounds the pivot part D112, and then enters the front leg D22 of the frame via the perforation part D116, and the second end D320 of the dragging part D300 is finally connected to the locking member D210 of the locking part D200, thusly, the locking member D210 may accordingly leave the locking hole D240 or enter the locking hole D240 by the dragging part D300 moving to its second position or its first position. According to one of the embodiments, the pivot part D112 is provided with a guiding slot, the second end D320 of the dragging part D300 surrounds the guiding slot, and then enters the front leg D22 of the frame via the perforation part D116, and finally connected to the locking member D210.

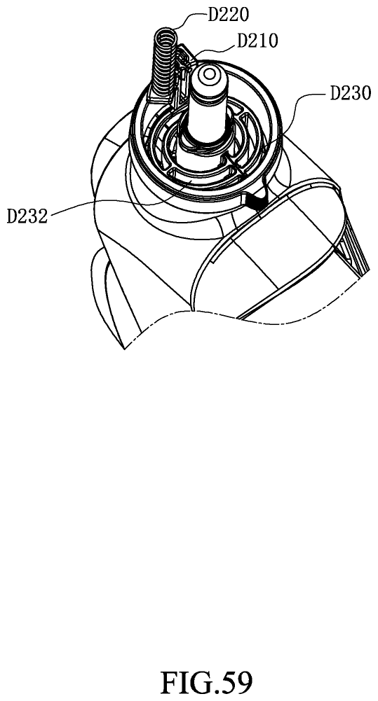

Next, the detailed structure of the locking part D200 will be described with reference to FIG. 59, which is an enlarged schematic view showing the structure of the locking part D200 according to the embodiment of the application. The locking part D200 includes not only the locking member D210 and the locking hole D240, but also an elastic member D220 and a rotating part D230. The elastic member D220 may abut and push the locking member D210 when the frame D20 is folded, and make the locking member D201 fall. According to an embodiment, the elastic member D220 is an abutting and pushing spring. The elastic member D220 will apply a pushing force to the locking member D210 to make the locking member D210 fall down when the dragging part D300 moves downward and to its first position, and the locking member D210 may abut and push the rotating part D230 after falling down, such that the locking hole D240 aligns with the locking member D210 for locking. According to the shown embodiment, both the rotating part D230 and the locking hole D240 are located on the end face D321 of the wheel seat D32. The rotating part D230 is a spiral surface arranged on the end face D321, and according to a preferred embodiment, the locking hole is arranged at a lowest point of the spiral surface. The locking member D210 may rotate clockwise or counterclockwise along the spiral surface to reach the lowest point for entering the locking hole D240, and in case that the frame is unfolded from its folded state, the locking member D210 may also rotate clockwise or counterclockwise along the spiral surface from the lowest point to away from the locking hole D240 after it leaves from the locking hole D240. According to the embodiment shown in the FIG. 59, the spiral surface is provided with at least one groove D232 to reduce its total weight.

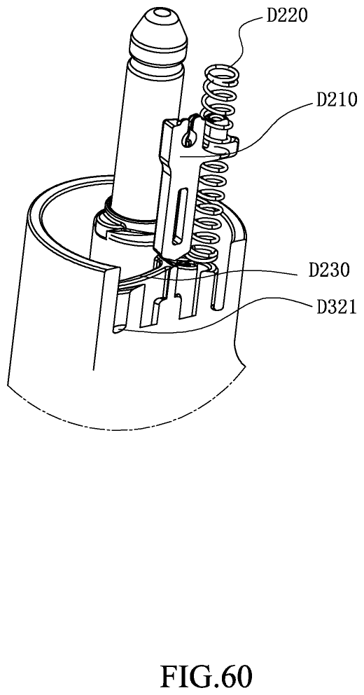

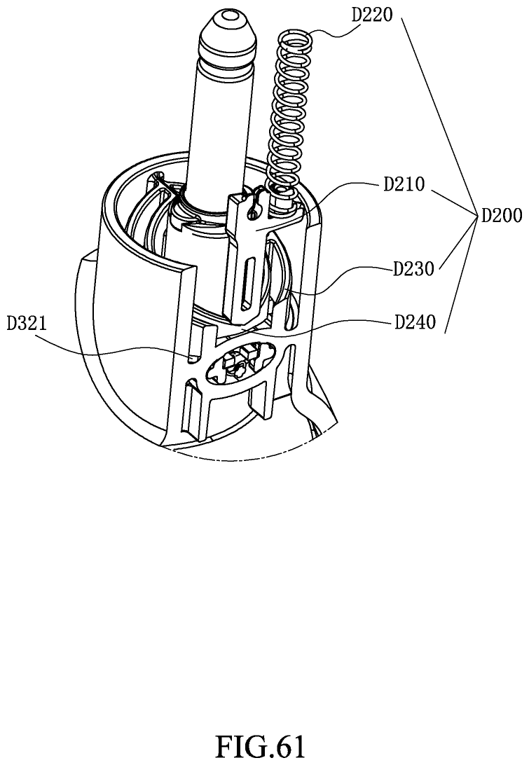

Hereinafter, the operation mode of the locking member D210 along the rotating part D230 will be described in detail with reference to FIGS. 60 and 61, in which FIG. 60 is an enlarged schematic view showing the structure of the locking part D200 according to the embodiment of the application, where the locking part D200 is in an unlocked state before rotating; and FIG. 61 is an enlarged schematic view showing the structure of the locking part D200 according to the embodiment of the application, where the locking part D200 is in a locked state after rotating. As shown in FIG. 60, at this time, the dragging part D300 is in a state of being pulled upward, the elastic member D220 is compressed by the locking member D210, and the locking member D210 is located at a high point of the spiral surface. According to a preferable embodiment, the locking member D210 is located at a highest point of the spiral surface. In case that the dragging part D300 is in a state of being pushed downward, as shown in FIG. 61, the locking member D210 falls down and rotates along the spiral surface until reaches the position of the locking hole D240 and enters the locking hole D240 to be locked under the abutting and pushing force of the elastic member D220. In this process, the locking member D210 may abut on and push the wheel seat D32 along the spiral surface at the same time, so the wheel D30 will also rotate accordingly. According to a preferred embodiment, the locking hole D240 is located at the lowest point of the spiral surface. Of course, other position arrangements are also feasible, that is, the position of the locking hole D240 may be arranged according to a required rotation angle of the wheel D30.

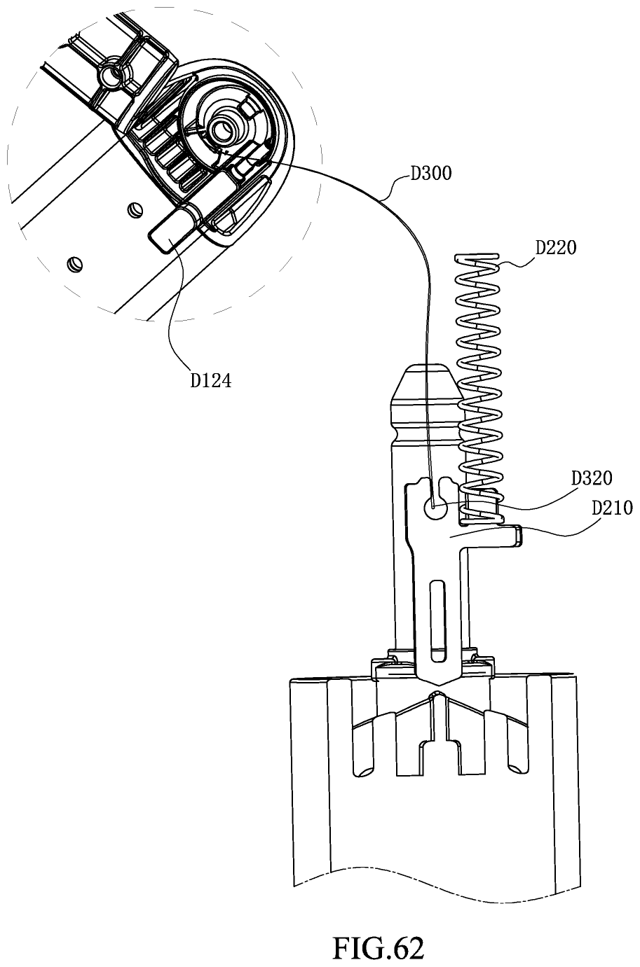

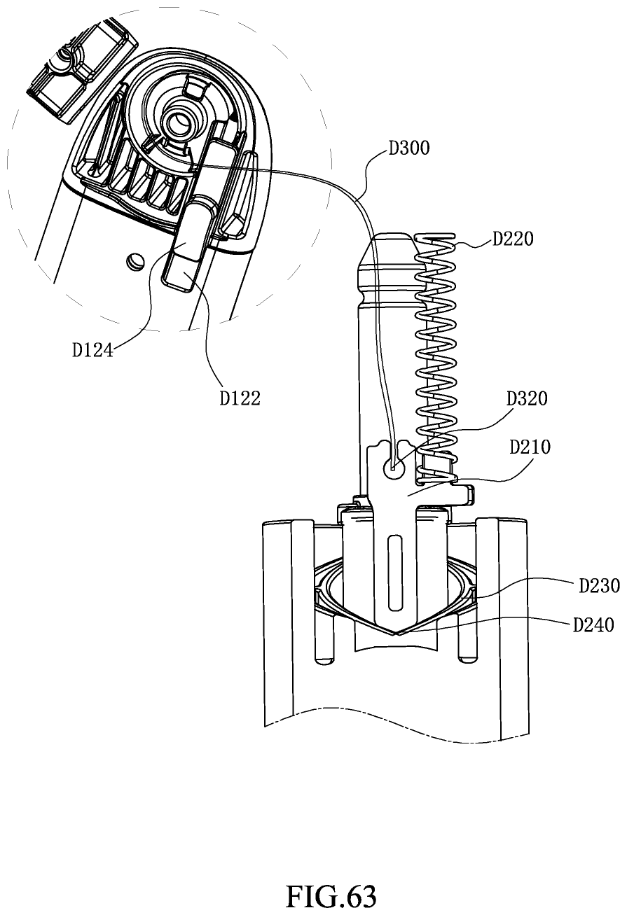

Next, the cooperation mode of the driving part D100, the locking part D200, and the dragging part D300 will be entirely explained with reference to FIGS. 62 and 63, in which FIG. 62 is an enlarged schematic view showing the driving part D100 and the locking part D 200 cooperated with each other according to the embodiment of the application, where the child stroller D1 is in an unfolded state; and FIG. 63 is an enlarged schematic view showing the driving part D100 and the locking part D200 cooperated with each other according to the embodiment of the application, where the child stroller D1 is in a folded state. In the unfolded state shown in FIG. 62, since the abutting and pushing part D114 of the pushing member D110 abuts against the protruding end D124 of the sliding member D120, the sliding member D120 moves down along the extending direction of the rear leg D24, so as to pull the dragging part D300 upward to make the dragging part D300 in its second position, the locking member D210 of the locking part D200 is pulled accordingly, such that the locking member D210 moves up away from the locking hole D240, and the elastic member D220 will be compressed in the process. Moreover, in the folded state in Figure FIG. 63, along with folding of the frame D20, such as folding of the front leg D22, the rear leg D24, and the handlebar assembly with respect to each other, the abutting and pushing part D114 of the pushing member D110 may rotate clockwise, thereby separating from abutting of the protruding end D124 of the sliding member D120, and the sliding member D120 will move up along the extending direction of the rear leg D24, the dragging part D300 will move downward accordingly. In case that the dragging part D300 is in its first position, under abutting and pushing force of the elastic member D220, the locking member D210 will fall down, and the falling locking member D210 will move along the spiral surface, and will bring the wheel seat D32 and the wheel D30 to rotate at the same time, until the locking member D210 enters the locking hole D240. Such rotation of the locking member D210 may be clockwise or counterclockwise, and correspondingly, the spiral surface may be arranged clockwise or counterclockwise from a high point to a low point on the end face D321.

In case that the frame D20 is unfolded again, the abutting and pushing part D114 of the pushing member D110 will rotate counterclockwise, thus abutting and pushing the protruding end D124 of the sliding member D120 again, and the sliding member D120 will move down along the extending direction of the rear leg D24, thereby pulling the dragging part D300 upward, and the dragging part D300 will correspondingly pull the locking member D210 of the locking part D200, such that the locking member D210 moves up away from the locking hole D240, and the upward movement of the locking member D210 may be performed by rotating clockwise or counterclockwise along the spiral surface of the rotating part D230 until it returns to the high point of the spiral surface again.

According to this embodiment, in case that the frame D20 is folded, along with falling of the locking member D210, the locking member D210 will rotate along the spiral surface until falling into the locking hole D240. In this process, the falling locking member D210 will abut on and push the wheel seat D32 to rotate together with the wheel D30, so the wheel D30 may be rotated and oriented forward when the frame D20 is folded, thereby avoiding interference with, for example, a crossbar of the frame D20, and the frame D20 may be smoothly folded. The wheel D30 according to this embodiment may be a front wheel, but it is not limited there.

Since the characteristics of the invention may be embodied in various forms without departing from the characteristics of the invention, it should also be understood, the above embodiments are not limited to any details described above, unless otherwise specified, but should be broadly interpreted as falling within the scope defined by the appended claims, and therefore, all modifications and alterations that fall within the scope and bounds of the claims or equivalents of such ranges and bounds should be covered by the appended claims.

### LIST OF REFERENCE SIGNS

```
  First Embodiment:
  Child Stroller: A1
    Frame: A20
            Front Leg: A22 Rear Leg: A24 Handlebar linkage part: A26
    Wheel: A30
            Wheel Seat: A32
    Wheel Orientation Mechanism: A10
            Driving Part: A100
                Driving Member: A110
                      End Part: A111 Accommodation Slot: A112 Orientation Slot: A113
                              Bevel Angle: A111a
                Triggering part: A120
                      Driving Bevel Surface: A121 Concave Curved Surface: A122
                First Reset Member: A130
                Chute: A140
                        Fixing Part: A141 Orientation Part: A142
          Locking Part: A200
                        Locking Pin: A210
                        Locking Hole: A220
                        Second Reset Member: A230
          Dragging Part: A300
                        First End: A310
                        Second End: A320
          Guiding Part: A400
                        Guiding Slot: A410
          First Direction: S1
          Second Direction: S2
          Circle: Q1
          Circle: Q2
          Part: A
          Part B
  Second Embodiment:
  B100: Frame Body, B110: Front Leg Support Rod, B111: Rotation Shaft,
B112: Inclined Part, B113: Vertical Part, B114: Inner Plug Member, B115: Pulley,
B120: Rear Leg Support Rod, B130: Armrest Support Rod, B140: Foldable joint,
B150: Fixing Member, B160: Pedal,
  B200: Wheel Assembly, B210: Wheel Seat, B211: Connecting Seat, B211a: Pivot Hole,
B211b: tooth Slot, B212: Connecting Frame, B212a: Connecting Member,
B220: Wheel Body,
  B300: Orientation Assembly, B310: Orientation Element, B310′: Orientation Pin,
B311: Abutting and Pushing Element, B311′: Abutting and Pushing Pin,
B312: Chamfer Structure, B320: Orientation Slot, B330: First Reset Member,
  B400: Driving Assembly, B410: Driving Member, B411: Turntable,
B412: Transmission Tooth, B413: Driving Tooth, B413a: First Bevel Edge,
B413b: Second Bevel Edge, B420: Dragging part, B430: Second Reset Member,
B440: Sheath,
  B500: Transmission Wheel.
  Third Embodiment:
  Child Stroller: C1
        Frame: C20
              Front Leg: C22 Rear Leg: C24 Handlebar Linkage Part: C26
        Wheel: C30
              Wheel Seat: C32
                    End Face: C321
        Pivot Joint: T
  Wheel Orientation Mechanism: C10
        Driving Guide Part: C100
                Pulley group: C110
                          First Pulley: C112 Second Pulley: C 113
                Guide post group: C120
                          First Guide Post: C122 Second Guide Post: C123
        Locking Part: C200
                  Locking Member: C210 Elastic Member: C220 Locking Hole: C240
        Dragging Part: C300
                  First End: C310
                  Second End: C320
  Fourth Embodiment:
  Child Stroller: D1
      Frame: D20
            Front Leg: D22 Rear Leg: D24 Handlebar linkage part D26
  Wheel: D30
        Wheel Seat: D32
                End Face: D321
        Driving Part: D100
                Pushing Member: D110
                    Pivot Part: D112 Abutting and pushing part D114 Perforation Part: D116
        Sliding Member: D120
                    Sliding Part: D122 Protruding End: D124 Accommodating Hole: D126
        Locking Part: D200
                    Locking Member D210
                    Elastic Member: D220
                    Rotating part: D230
                            Groove: D232
                    Locking Hole: D240
        Dragging Part: D300
                  First End: D310
                  Second End: D320
```

1-67. (canceled)

68. A wheel orientation mechanism, comprising:
a driving part including a driving member and a triggering part, wherein the triggering part is actuated by folding and unfolding actions of a frame, such that the driving member moves respectively in a first direction and a second direction opposite to each other;
a locking part, wherein the locking part carries out locking and unlocking respectively by movement of the driving member in the first direction and the second direction; and
a dragging part including a first end and a second end, wherein the first end is connected to the driving part, and the second end is connected to the locking part.

69. The wheel orientation mechanism according to claim 68, wherein the triggering part rotates correspondingly through folding and unfolding actions of the frame, and the driving member moves against the triggering part.

70. The wheel orientation mechanism according to claim 68, wherein the driving part further comprises a chute, and the driving member slides in the chute respectively along the first direction and the second direction.

71. The wheel orientation mechanism according to claim 68, wherein the triggering part comprises a driving bevel surface and a concave curved surface, wherein the driving bevel surface is located on one side of the triggering part, and the concave curved surface is arranged adjacent to the driving bevel surface and located on the other side of the triggering part,
wherein the end part of the driving member slides from abutting against the concave curved surface to abutting against the driving bevel surface when the frame is folded from an unfolded position; and the end part of the driving member slides from abutting against the driving bevel surface to abutting against the concave curved surface when the frame is unfolded from a folded position,
wherein the end part of the driving member abuts against an end edge on a side of the driving bevel surface when the frame is in a completely folded state.

72. The wheel orientation mechanism according to claim 68, wherein the wheel orientation mechanism further comprises a first reset member and a second reset member, the first reset member is arranged at the driving part, and the second reset member is arranged at the locking part.

73. The wheel orientation mechanism according to claim 68, wherein the wheel orientation mechanism further comprises a guiding part including a guiding slot, and a part of the dragging part between the first end and the second end is located in the guiding slot.

74. A child stroller, comprising the wheel orientation mechanism according to claim 68, wherein the locking part is arranged at a pivot joint between the front leg of the frame and a wheel seat, and the driving part is at least partially arranged at a pivot joint among a front leg, a rear leg, and a handlebar linkage part of the frame.

75. The child stroller according to claim 74, wherein the triggering part of the driving part is arranged at the pivot joint among the front leg, the rear leg, and the handlebar linkage part of the frame.

76. A wheel orientation mechanism comprising:
a driving guide part;
a locking part, including a locking member and a locking hole;
a dragging part, including a first end connected to a frame via the driving guide part and a second end connected to the locking member, and
wherein the dragging part is tightened or loosened by the driving guide part along with an unfolding or folding action of the frame, such that the locking member is respectively separated from or inserted into the locking hole to realize unlocking or locking.

77. The wheel orientation mechanism according to claim 76, wherein the driving guide part includes a pulley group and a guide post group, and the pulley group and the guide post group are arranged along a moving path of the dragging part.

78. The wheel orientation mechanism according to claim 77, wherein the pulley group includes a first pulley and a second pulley, wherein the guide post group includes a first guide post and a second guide post, and the first end of the dragging part is connected to a handlebar assembly of the frame via the first pulley, the first guide post, the second guide post, and the second pulley in turn.

79. The wheel orientation mechanism according to claim 78, wherein a rear leg of the frame is provided with a pivot joint, and the pivot joint has a lower end connected to a front leg of the frame, and an upper end connected to the handlebar assembly of the frame, and
wherein the first pulley and the second pulley are distributed on upper and lower sides of the pivot joint, and the first guide post and the second guide post are also distributed on upper and lower sides of the pivot joint.

80. The wheel orientation mechanism according to claim 79, wherein the handlebar assembly includes a handlebar linkage part, the first end of the dragging part is connected to the handlebar linkage part, and the upper end of the pivot joint is pivoted to the handlebar linkage part.

81. The wheel orientation mechanism according to claim 80, wherein the first pulley is arranged at a pivot connection between the pivot joint and the front leg, and the second pulley is arranged at a pivot connection between the pivot joint and the handlebar linkage part.

82. The wheel orientation mechanism according to claim 76, wherein the locking part further includes a rotating part, and the locking member abuts and pushes the rotating part after falling such that the locking hole is rotated to align with the locking member for locking.

83. The wheel orientation mechanism according to claim 82, wherein the rotating part and the locking hole are both located on an end face of a wheel seat of the wheel faced to the frame,
wherein the rotating part is a continuous spiral surface located on the end face, and the locking hole is located below the lowest point of the spiral surface, and
wherein a stepped surface is arranged between the lowest point of the spiral surface and the locking hole.

84. A wheel orientation mechanism comprising:
a driving part;
a locking part, including a locking member and a locking hole;
a dragging part, including a first end connected to the driving part and a second end connected to the locking member, and
wherein the dragging part moves between a first position in which the locking member is inserted into the locking hole to realize locking and a second position in which the locking member is separated from the locking hole to realize unlocking through the driving part along with an unfolding or folding action of the frame.

85. The wheel orientation mechanism according to claim 84, wherein the driving part includes:
a pushing member, rotating correspondingly along with an unfolding or folding action of the frame; and
a sliding member, linearly moving to and fro through pushing of the pushing member.

86. The wheel orientation mechanism according to claim 85, wherein the pushing member is provided at a front leg of the frame and includes:
a pivot part around which the pushing member rotates; and
an abutting and pushing part, located at one end of the pushing member and protruding outward, wherein the abutting and pushing part abuts and pushes the sliding member when the frame is unfolded.

87. The wheel orientation mechanism according to claim 86, wherein the sliding member is provided at the rear leg of the frame and includes:
a sliding part which always abuts and supports a tube of the rear leg, and slides along the tube of the rear leg when the sliding member linearly moves;
a protruding end, wherein the abutting and pushing part abuts and pushes the protruding end when the frame is unfolded.
